(19) United States
(12) Patent Application Publication
(10) Pub. No.: US 2026/0197828 A1
(43) Pub. Date: Jul. 9, 2026

(54) CONTROL INFORMATION FOR UPLINK TRANSMISSIONS ON PERIODIC RESOURCES

(71) Applicant: Sony Group Corporation, Tokyo (JP)

(72) Inventors: Yassin Aden AWAD, Basingstoke (GB); Vivek SHARMA, Basingstoke (GB); Yuxin WEI, Basingstoke (GB); Hideji WAKABAYASHI, Basingstoke (GB); Samuel Asangbeng ATUNGSIRI, Basingstoke (GB)

(73) Assignee: Sony Group Corporation, Tokyo (JP)

(21) Appl. No.: 18/874,591

(22) PCT Filed: Jun. 13, 2023
(86) PCT No.: PCT/EP2023/065720

§ 371 Date: Dec. 13, 2024

(30) Foreign Application Priority Data
Jun. 23, 2022 (EP) 22180840.5

(51) Int. Cl. H04W 72/21; H04L 1/00

(52) U.S. Cl. CPC H04W 72/21; H04L 1/0003; H04L 1/0009

(57) ABSTRACT

The present disclosure relates to transmissions from communications devices to infrastructure equipment in a wireless communications network, using a plurality of periodically occurring instances of uplink resources. Control information is transmitted for specific instances of the uplink resources based on predetermined conditions. Predetermined condition include: uplink data to be transmitted in the particular instance of uplink resources is a start or an end of the uplink data to be transmitted, an amount of uplink data to be transmitted in the particular instance of uplink resources is different to an amount transmitted in a previous instance of uplink resources, and a modulation and coding scheme encoding the uplink data to be transmitted in the particular instance of uplink resources is different to a modulation and coding scheme used to encode uplink data transmitted in a previous instance of uplink resources.

### BACKGROUND

### Field of Disclosure

The present disclosure relates to communications devices, infrastructure equipment and methods for the more efficient operation of a communications device in a wireless communications network.

The present applications claims the Paris Convention priority from European patent application number EP22180840.5, filed on 23 Jun. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Some embodiments of the present technique can provide a communications device for operation in a wireless communications network, the communications device comprising a transceiver, configured to transmit signals to and/or receive signals from an infrastructure equipment forming part of the wireless communications network via a wireless access interface provided by the wireless communications network, the signals representing data, a controller, configured to control the transceiver, and a memory storing instructions. The execution of these instructions causes the communications device to determine that the communications device has uplink data to transmit to the wireless communications network, determine a plurality of periodically occurring instances of uplink resources of the wireless access interface in which the uplink data is to be transmitted, the uplink resources comprising at least a data resource, determine, independently from the wireless communications network, control information related to the uplink data, and transmit to the wireless communications network the determined control information for a particular one of the instances of uplink resources if a predetermined condition is met. Here, the predetermined condition is at least one of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink resources, and a modulation and coding scheme encoding the uplink data to be transmitted in the particular instance of uplink resources is different to a modulation and coding scheme used to encode uplink data transmitted in a previous instance of uplink resources. They also cause the communications device to transmit the uplink data to the wireless communications network via the data resource in each of the plurality of instances of uplink resources.

Other embodiments of the present technique can provide a method of operating a first communications device configured to transmit signals to and/or receive signals from a first infrastructure equipment forming part of a wireless communications network via a wireless access interface provided by the wireless communications network, the method comprising determining that the communication device has uplink data to transmit to the wireless communications network, determining a plurality of periodically occurring instances of uplink resources of the wireless access interface in which the uplink data is to be transmitted, the uplink resources comprising at least a data resource, determining, independently from the wireless communications network, control information related to the uplink data, transmitting to the wireless communications network the determined control information for a particular instance of uplink resources, transmitting the uplink data to the wireless communications network via the data resource of the particular instance of uplink resources, receiving from a second infrastructure equipment forming part of the wireless communications network a feedback indication indicating that interference measured in a cell corresponding to the second infrastructure equipment exceeds a predetermined threshold, and adapting the transmission of the uplink data and the determined control information to the wireless communications network in response to receiving the feedback indication.

Embodiments of the present technique, which, in addition to communications devices, relate to infrastructure equipment, methods of operating communications devices and infrastructure equipment, circuitry for communications devices and infrastructure equipment, wireless communications systems, computer programs, and computer-readable storage mediums, can allow for more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates how different UEs can be assigned separate spatial-layer resources;

FIG. 5 illustrates how different UEs can be assigned separate frequency-domain resources;

FIG. 6 illustrates how different UEs can be assigned separate time-domain resources;

FIG. 7 shows an example of pre-assigned dedicated resources for UE-based scheduling comprising separate control and data resources;

FIG. 8 shows a part schematic, part message flow diagram representation of a wireless communications system comprising a communications device and an infrastructure equipment in accordance with embodiments of the present technique;

FIG. 9 shows a flow diagram illustrating a process of communications in a communications system in accordance with embodiments of the present technique;

FIG. 10 shows an example of inclusion of control information in a communication with an infrastructure equipment when certain predetermined conditions are met in accordance with embodiments of the present technique;

FIG. 11 shows an example of physical resource blocks used by a communications device to transmit data to an infrastructure equipment demonstrating the use of frequency hopping in accordance with embodiments of the present technique;

FIG. 12 shows a part schematic, part message flow diagram representation of a wireless communications system comprising a communications device and an infrastructure equipment in accordance with embodiments of the present technique; and

FIGS. 13A and 13B show a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

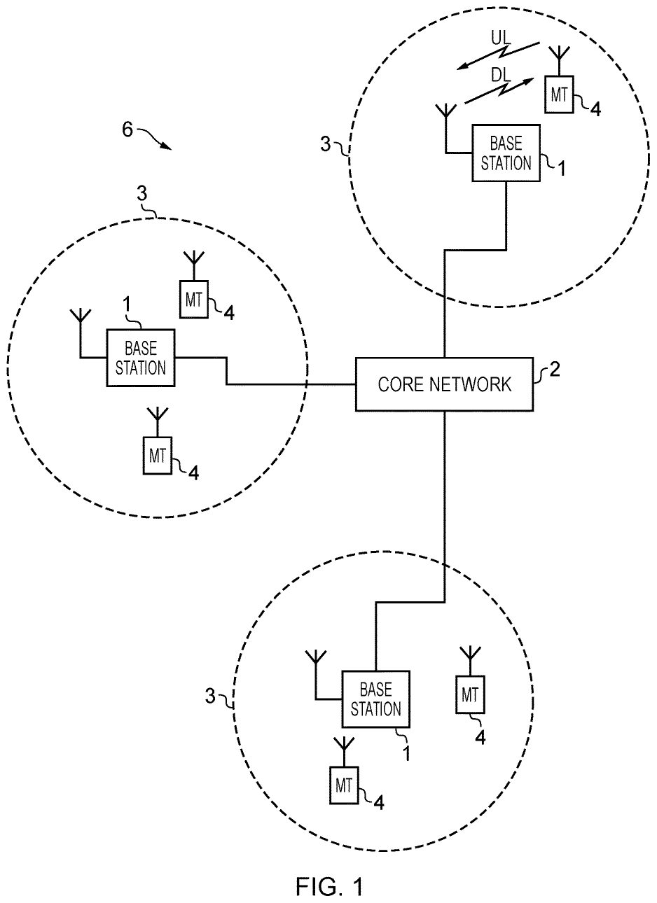

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

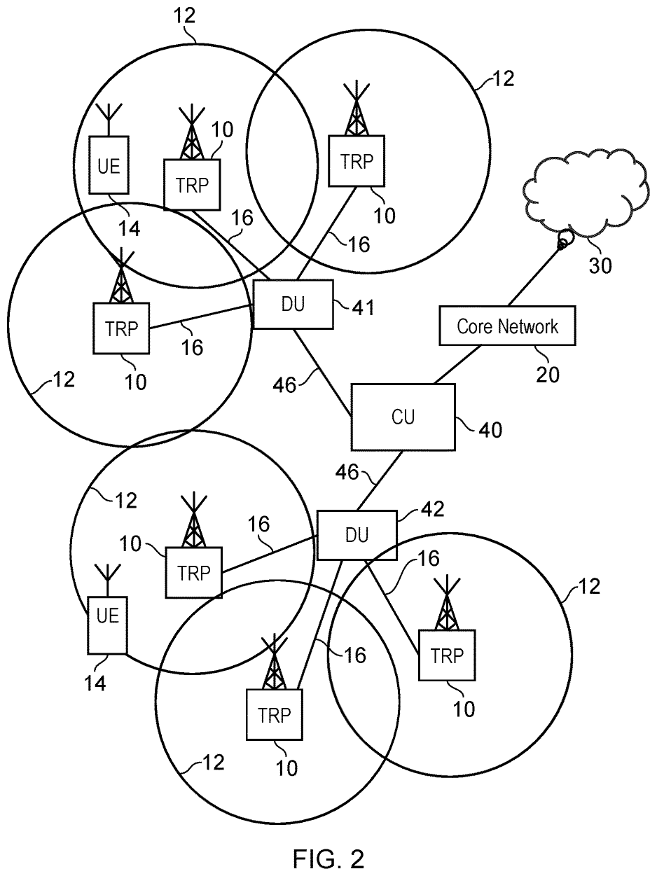

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems.

Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

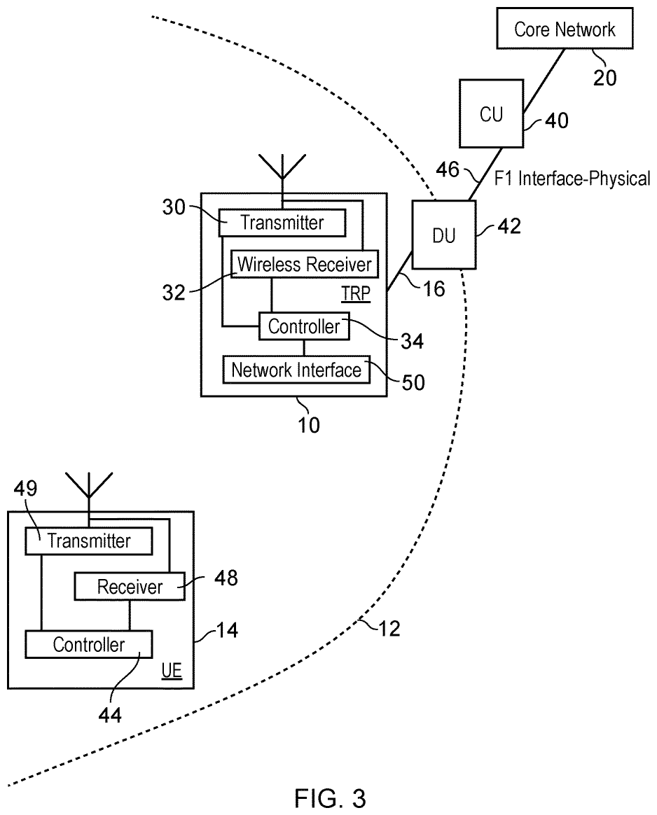

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### URLLC and eURLLC

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999 %) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which one of the objectives is to enhance UE feedback for Hybrid Automatic Repeat Request Acknowledgements (HARQ-ACK) for Physical Downlink Shared Channel (PDSCH) transmissions.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IlIOT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful.

A typical use case (e.g. for broadcast TV production) is a camera transmitting a video stream using the User Data Protocol (UDP)/Internet Protocol (IP) protocol stack. In layer 2 of this protocol stack (L2), Radio Link Control-Unacknowledged Mode (RLC-UM) mode will be configured for UDP. Accordingly, dedicated (and probably regular) resources may be configured by the network, using techniques like periodic UL grant or configured grant. Such techniques are already developed and available.

As an example scenario, there might be a video algorithm which requires a camera not to transmit any uplink video frames if the view does not change. But as soon as the view changes, video codecs will have data available for transmission in L2 buffers. If traditional techniques are relied upon, the camera/UE must request UL resources before transmitting on the uplink. This likely involves additional signalling and latency which is detrimental to live production.

In this case, the UE must wait for an UL slot to send a physical uplink control channel (PUCCH), where this PUCCH comprises a scheduling request (SR), and then must wait again for the network to receive this SR, allocate resources for the UE, and indicate this resource allocation within downlink control information (DCI) carried by a physical downlink control channel (PDCCH). Furthermore, the network does not necessarily know how much data is in the UE's buffer, and so can only schedule the UE for limited data, until the UE sends a buffer status report (BSR) via, for example, a physical uplink shared channel (PUSCH), and must wait again to be scheduled for a larger amount of data based on the BSR.

Further aspects of UL scheduling may be found in co-pending European patent application published under number EP3837895 [5], the contents of which are hereby incorporated by reference.

### Link Adaptation in Existing Mobile Communications Networks

The lower layers (MAC and physical layers) of a mobile communication system are designed to create a radio waveform used for conveying data between a transmitter and receiver given some expected radio propagation conditions between the communicating gNB and the UE. In traditional link-layer designs, these layers are designed to allow the radio-communication system to cope with a given degree of radio propagation impairment. The success of mobile communication systems over the last few decades has been mainly due to the adoption of link adaptation that helps to maximise the throughput. In mobile communication systems such as 3G, 4G and 5G, the link-layer is designed with many choices for the forward error correction (FEC) code rates, modulation constellations, waveform type, transmit power levels. These can be jointly selected into sets of transmission parameters. Each set can be thought of as a parametrisation for the generation of the transmitted signal resulting from the joint choices that make the set. A given set is expected to generate a waveform or signal for transmission that is different from what another set would generate. Therefore, a deliberate choice can be made of a particular set of transmission parameters with the expectation that it would generate a transmission signal that is somehow more suitable for a prevailing set of radio channel propagation conditions than another set.

This method of designing link-layers is rather long-winded and laborious because it is difficult to deliberately determine the set of choices for all the configuration parameters. This is firstly, and especially, because the process of choosing between particular communication signal processing techniques such as FEC coding schemes (Low Density Parity Check (LDPC) codes, Turbo codes, or Polar codes, for example) is not trivial. Secondly, this is because even after a particular communication signal processing technique has been chosen, deciding on the set of possible configurations of the chosen technique that have to be designed and standardised is also an onerous process. As an example, if we consider only the FEC, then the radio communication system designer may have to first choose the FEC scheme (LDPC, Turbo or Polar codes etc.), then having chosen the FEC scheme, would need to then decide what block sizes and code rates to support etc. before proceeding to a similar process for modulation constellations etc.

Assuming that the radio-communication system has been designed already, such a system design has already chosen a coding scheme. In addition, it supports a designed number of possible codeword block sizes, a designed number of code rates per block size, a designed number of modulation constellations etc. Link adaptation allows the UE and gNB to work together to determine automatically:
1. The prevailing radio propagation conditions that will affect the transmitted data; and
2. The most appropriate set of link-layer configuration parameters (block size, code rate, modulation constellation etc.) to use so as to maximise throughput and/or transmission resource utilisation for the transmitted data within target reliability and/or latency under the prevailing radio propagation conditions.

This choice of an appropriate set of link-layer configuration parameters is also not trivial as it presents a somewhat multi-dimensional problem with the decision depending for example on the given transmission block size and the prevailing radio propagation channel conditions etc. Link adaptation in 4G and 5G systems is limited to the selection of a configuration from amongst a set of designed choices. For link adaptation of the downlink (DL), the UE measures channel quality parameters on the reception of reference signals transmitted by the BS. The channel quality is then signalled to the BS as a channel quality indicator (CQI) that can be either narrowband or wideband depending on the bandwidth of the reference signals used for its measurement. Based on this CQI report from the UE, the BS can adapt its DL transmissions to maximise throughput. Similarly, for the UL the BS measures channel quality parameters from reception of sounding reference signals (SRS) transmitted by the UE and uses the results of these measurements to instruct the UE how to adapt UL transmissions to maximise throughput. In 4G and 5G systems, since the FEC type for data channels is fixed, link adaptation therefore only involves the selection from a set of possible FEC code rates and modulation constellations—i.e. the modulation and coding scheme (MCS). Transmit power can also be thought of as an aspect of link adaptation, but is not typically adjusted per transmission block.

### Legacy Scheduling Methods in NR (5G)

In cellular wireless communications, the channel between a mobile terminal and the base-station experiences typically rapid and significant variations which impact the quality of the received signal. In the small-scale variation, the channel goes through frequency selective fading which results in rapid and random variations in the channel attenuation. In the large-scale variation, there are shadowing and distance related pathloss which affect the average received signal strength. In addition, there is interference arising from transmissions from nearby cells and terminals which distorts the signal at the receiver side.

In practice, the heart of mitigating and exploiting the variations of the channel condition is the scheduling mechanism that implements link adaptation algorithms, such as adaptive modulation and coding schemes (AMCS), dynamic power control and channel-dependent scheduling.

In NR, the downlink and uplink multi-user schedulers are located at the base-station (gNB) where, in principle, the scheduler assigns the resources for the users with the best channel conditions in a given instance in both the UL and DL while taking into account the fairness among users as well. There are two types of scheduling mechanism, and these are termed as dynamic scheduling (or dynamic grant) and semi-persistent scheduling (or configured grant).

In dynamic multi-user scheduling for downlink transmissions, based on the instantaneous channel condition where the terminal feeds back the channel quality indicator (CQI) derived from downlink reference signals (RS) at regular time-intervals to the gNB, the scheduler at the gNB, after receiving the CQI, decides the best modulation and coding scheme (MCS), best “available” frequency resources (physical resource blocks (PRBs)) and adequate power for the downlink data transmissions for some users at a given subframe/slot. The downlink scheduling decisions, which are known as scheduling assignments, are carried by downlink control information (DCI), which is transmitted in the downlink to the scheduled users.

Similarly, for the dynamic multi-user scheduling for uplink transmission, based on the instantaneous channel condition where the terminal sends channel SRS at regular time-intervals to the gNB, the scheduler at the gNB, after deriving the CQI based on the last received SRS, decides the best modulation and coding scheme, best frequency resources (PRBs) for the uplink data transmissions from some users at a given subframe/slot. The uplink scheduling decisions, which are also known as scheduling assignments, are carried by DCI which is transmitted in the downlink to the scheduled users.

For semi-persistent scheduling (SPS) however, the resources are pre-configured semi-statically (e.g. via radio resource control (RRC) signalling) with a certain periodicity, where this periodicity is aligned with the data arrival rate for a particular service. There is an SPS for the downlink (known as DL SPS) and an SPS for the uplink (referred to as configured grant (CG)).

CG resources are mainly intended to deliver multiple traffic classes in a timely manner from the terminal, where such traffic classes have low data rates and some kind of periodicity, as specified in URLLC/IIOT in NR Rel-16/17. Some examples of the different traffic classes include industrial automation (future factory), energy power distribution, and intelligent transport systems, voice.

### Issues with Legacy Scheduling Methods

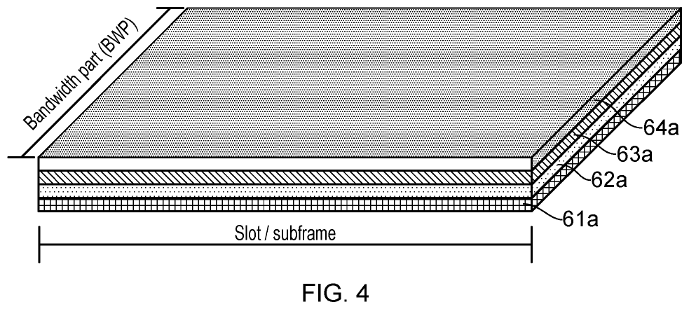

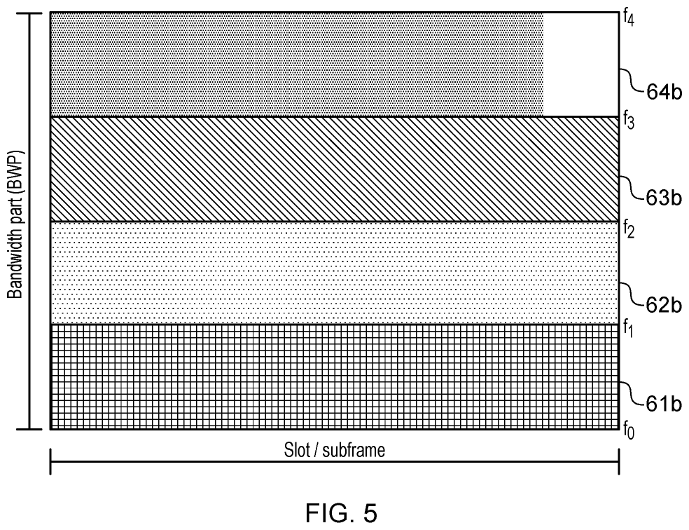

As described above, CG resources are mainly intended for traffic with a low data rate and with some kind of periodicity, as specified in URLLC/IIOT in NR Rel-16/17. However, for traffic with a high data rate and which requires low latency, larger resources would be needed. In this case, a UE can be pre-configured with dedicated larger resources for such uplink data transmissions. These resources can be allocated by one of the following methods (or by a combination of these methods):
Spatial-domain allocation: In this method, the gNB pre-allocates a specific spatial layer to the UE, where different UEs are allocated to different spatial layers in a bandwidth part (BWP), similar to multi-user multiple-input and multiple-output (MU-MIMO). This means that a UE has pre-allocated resources in the spatial-domain for both control and data. Hence, when the UE has data to transmit, the UE uses resources in the spatial layer reserved for it. The spatial-domain resource can be configured for a full set or a sub-set of the BWP resources during a given transmission time interval. As shown in the example in FIG. 4, a first UE may be assigned a first spatial layer 61a, a second UE may be assigned a second spatial layer 62a, a third UE may be assigned a third spatial layer 63a, and a fourth UE may be assigned a fourth spatial layer 64a in a slot
Frequency-domain allocation: Similarly, to spatial-domain resources, dedicated frequency-domain resources can be pre-assigned to the UE where different UEs are allocated different frequency resources in a system bandwidth or a BWP during a given transmission time interval. Hence, when data arrives at the UE's buffer, the UE uses the frequency resources allocated for it. As shown in the example in FIG. 5, a first UE may be assigned a first frequency resource set 61b (i.e. frequency range f₀-f₁), a second UE may assigned a second frequency resource set 62b (i.e. frequency range f₁-f₂), a third UE may assigned a third frequency resource set 63b (i.e.

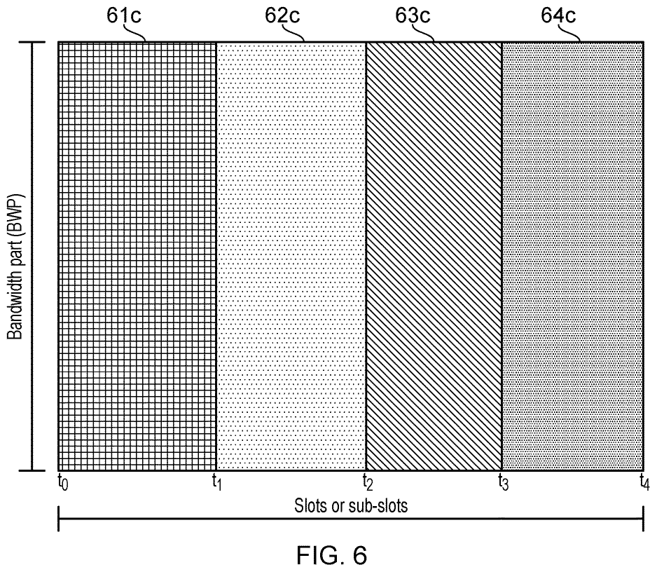

frequency range f₂-f₃), and a fourth UE may assigned a fourth frequency resource set 64b (i.e. frequency range f₃-f₄); and ·Time-domain allocation: Similarly, to both spatial and frequency-domain resources, dedicated time-domain resources can be pre-allocated for a UE where different UEs are allocated different time resources (e.g. different sub-slots or slots) in a component carrier or BWP. As shown in the example in FIG. 6, a first UE may be assigned a first time resource set 61c (i.e. time range t₀-t₁), a second UE2 may be assigned a second time resource set 62c (i.e. time range t₁-t₂), a third UE may be assigned a third time resource set 63c (i.e. time range t₂-t₃), and a fourth UE may be assigned a fourth time resource set 64c (i.e. time range t₃-t₄).

The first issue with using pre-configured dedicated resources for uplink data transmissions is that the resources are always reserved in advance, regardless of whether a UE actually has data to transmit or not. Even though a UE is able to release these pre-configured resources after finishing its UL data transmissions, the concern is that the signalling and commands for re-allocating/re-activating the resources will come from the network, which may result in some unbearable delays for a variety of services requiring for example high capacity URLLC on the uplink, and will also involve signalling from the UE to request resources either via a scheduling request (SR), or initiating a RACH procedure, or will involve resources being configured for idle periods (i.e. periods during which no transmissions are scheduled for a UE, but from which the UE can wake up immediately when necessary).

The second issue with pre-configured resources is that a UE may not be able to control completely the link adaptation parameters, such as frequency-domain scheduling, in order to choose the best frequency resources (PRBs) in a BWP, modulation and coding scheme (MCS), etc. Since the UE has to wait, after sending its measurements and/or SRS to the network, for the network to determine such link adaptation parameters and signal these to the UE, which both introduces latency and means that the most appropriate parameters may not be selected as the channel conditions may have changed between the time that the UE performed the measurements and/or transmitted the SRS and the time that the UE receives the link adaptation parameters from the gNB.

The third issue with pre-configured resources is that a UE may have to use all the resources whenever it has data to transmit, because the gNB and UE must each have knowledge of the allocated resources. This may mean that a UE must add padding bits in order to fill the remaining resources. This is clearly not desirable, as it increases the UE's transmission power consumption unnecessarily, and also generates interference for other UEs located in the same or a neighbouring cell.

Accordingly, some enhancements for UL scheduling will be required for future mobile communications networks, such as 5G-Advanced and 6G. A set of requirements for such enhanced UL scheduling can be envisioned as listed below:
Immediate transmission of the UL data in order to reduce latency, for example for applications requiring high capacity UL data with low latency;
Choosing appropriate link adaptation parameters, for example the best frequency resources (PRBs), MCS, power, etc. ;
Flexible resource allocation scheme, for example frequency domain resource allocation (FDRA) and/or time domain resource allocation (TDRA);
An efficient way of identifying a UE and its resource allocation dynamically at the gNB receiver; and
Improving spectral efficiency of the cell, so that when a UE is not using its allocated resources, another UE could in principle use such resources.

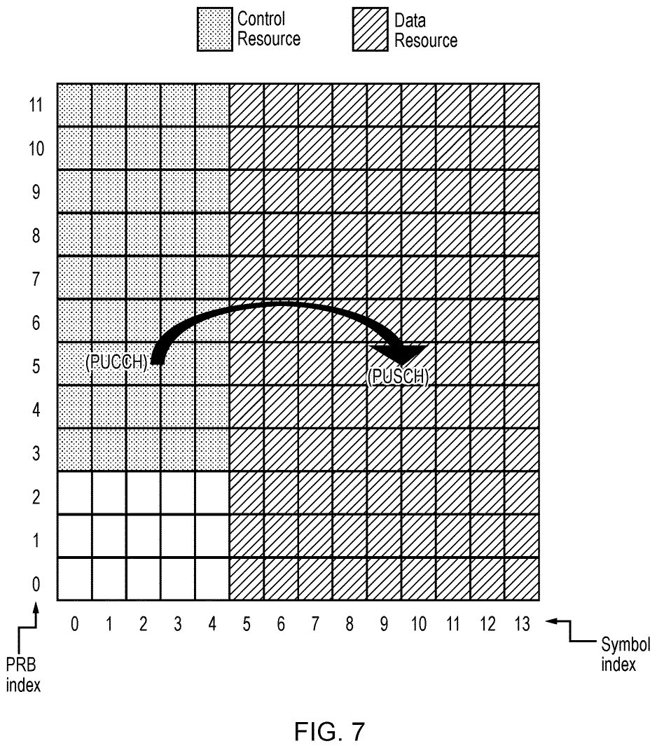

A solution to support UE-based scheduling in accordance with such requirements, where a UE is pre-assigned dedicated uplink resources for UL control and data transmissions in which these resources comprise UE-specific control resources and associated data resources, is provided in [5]. FIG. 7 illustrates an example of such separate control resources 71 and data resources 72 within pre-assigned dedicated resources for a UE, in accordance with what is described in [5].

Here, the UE takes control of its own scheduling decisions (or assignments) for its UL data transmissions, which are to be confined within the pre-assigned dedicated resources. The UE-specific control resource 71 is always available for scheduling the UL data on a specific BWP. Hence, this solution addresses the requirements captured above, including ensuring immediate UL data transmission, provision of appropriate link adaptation and a flexible resource allocation scheme, providing an efficient way of identifying the UE, and improving the spectral efficiency of the cell. In FIG. 7, as is described in [5], If the gNB decodes the PUCCH 73 received within the control resources 71, but not the PUSCH 74 received within the data resources 72, the gNB will send a negative acknowledgement (NACK) to the UE. Otherwise, the gNB will transmit a positive acknowledgement (ACK) to the UE indicating the successful decoding of the PUSCH.

Such solutions allow for the minimised delay at a UE when it has data to transmit with respect to legacy scheduling methods, as it does not have to wait to receive uplink grants from the network (and is not required to transmit a BSR for example in order to receive a grant large enough to transmit all of the data in its buffer). Some such solutions are described in co-pending European patent application number EP21204071.1 [6], the contents of which are hereby incorporated by reference. The concept of UE-based scheduling in [6] exploits configured grant (CG) resources, and such CG resources may comprise both a control part (e.g. for uplink control information (UCI) or other control information) and a data part. Here, as described in [6], this control part may be embedded in the CG PUSCH, or may be carried separately on a PUCCH, whilst the data part is transmitted on the CG PUSCH. One issue with such solutions however is that the transmission of the control part in each instance of the CG resources introduces constant overheads for the uplink transmissions as the control information (UCI) is always included in each CG resource instance for scheduling the UL data transmitted in that instance, reducing overall efficiency which may be, as described above, a particular issue for delay-sensitive services such as URLLC and XR.

Accordingly, embodiments of the present disclosure seek to address and provide solutions to the above-described issue of the control information overhead associated with UE-based scheduling.

### Dynamic Adaptation of CG Resource Configurations

In essence, embodiments of the present technique relate to a UE determining and transmitting to the infrastructure equipment control information only when certain pre-defined conditions are met. In example embodiments when these conditions are not met, the UE may determine that the control information is not required to be transmitted, and the uplink resources required for the control information may be repurposed for the uplink transmission of other data. Thus, on average, across a plurality of uplink transmission occasions, an overhead related to an uplink transmission may be reduced and throughput of data may be increased.

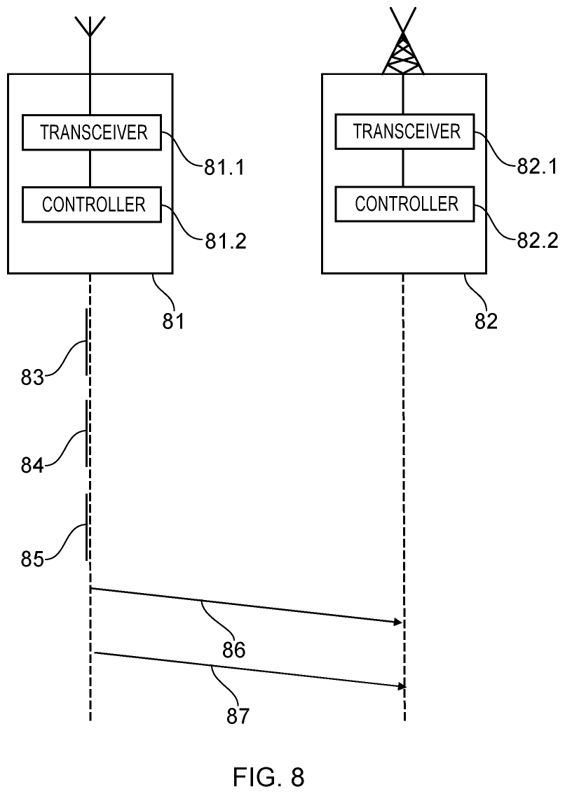

FIG. 8 shows a part schematic, part message flow diagram representation of a first wireless communications system comprising a communications device 81 and an infrastructure equipment 82 in accordance with at least some embodiments of the present technique. The communications device 81 is configured to transmit signals to and/or receive signals from the wireless communications network, for example, to and from the infrastructure equipment 82. Specifically, the communications device 81 may be configured to transmit data to and/or receive data from the wireless communications network (e.g. to/from the infrastructure equipment 82) via a wireless access interface provided by the wireless communications network (e.g. the Uu interface between the communications device 81 and the Radio Access Network (RAN), which includes the infrastructure equipment 82). The communications device 81 and the infrastructure equipment 82 each comprise a transceiver (or transceiver circuitry) 81.1, 82.1, a controller (or controller circuitry) 81.2, 82.2, a memory (not shown), and may comprise further elements not described herein. Each of the controllers 81.2, 82.2 may be, for example, a microprocessor, a CPU, or a dedicated chipset, etc.

As shown in the example of FIG. 8, the transceiver circuitry 81.1 and the controller circuitry 81.2 of the communications device 81 are configured in combination to determine 83 that the communications device 81 has uplink data to transmit to the wireless communications network (e.g. to the infrastructure equipment 82), to determine 84, independently from the wireless communications network (e.g. without receiving any instruction or scheduling information from the infrastructure equipment 82), a plurality of periodically occurring instances of uplink resources of the wireless access interface (e.g. preconfigured uplink resources such as configured grant (CG) resources) in which the uplink data is to be transmitted, wherein each of the instances of the uplink resources comprise at least a data resource, to determine 85, again independently from the wireless communications network (without receiving from the infrastructure equipment 82 any instruction, control information or parameters) control information related to the uplink data, to transmit 86 to the wireless communications network (e.g. to the infrastructure equipment 82) the determined control information related to the uplink data when certain predetermined conditions are met, and to transmit 87 to the wireless communications network (e.g. to the infrastructure equipment 82) the uplink data, where some portion of the data is transmitted in each of the instances of uplink resources that the communications device has scheduled for transmission of the uplink data.

Here, the predetermined condition may in at least some embodiments be one or more of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink data transmission, and a modulation and coding scheme encoding the uplink data to be transmitted in the particular instance of uplink resources is different to a modulation and coding scheme used to encode uplink data in a previous instance of uplink data transmission.

It would be apparent to the skilled person that certain details of FIG. 8 are not intended to limit the scope of the present disclosure, and that the determining steps 83-85 might be performed in a different order, or the transmission steps of 86-87 might be performed in a different order, or other steps not discussed above might be inserted into the process such as a transmission of control information to neighbouring cells to allow the neighbouring cells to monitor the interference to the transmissions in those cells by the uplink transmission described above.

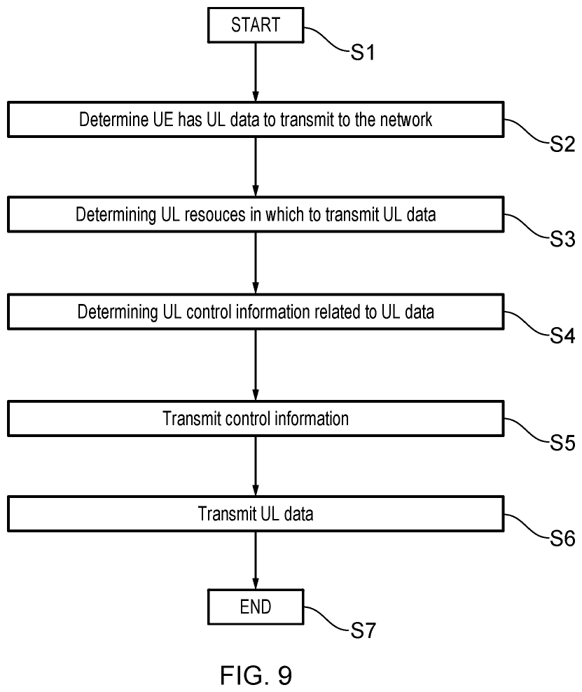

FIG. 9 shows a flow diagram illustrating an example process of communications in a communications system in accordance with embodiments of the present technique. The process shown by FIG. 9 is a method of operating a communications device (e.g. communications device 81 as shown in the example of FIG. 8) configured to transmit signals to and/or to receive signals from a wireless communications network (e.g. to or from an infrastructure equipment (e.g. infrastructure equipment 82 as shown in the example of FIG. 8) of the wireless communications network), the communications device operating in accordance with a communications device based scheduling mode in order to transmit uplink data.

The method begins in step S1. The method comprises, in step S2, determining that the communications device has uplink data to transmit to the wireless communications network. In step S3, the process comprises determining, independently from the wireless communications network, a plurality of periodically occurring instances of uplink resources of the wireless access interface in which the uplink data is to be transmitted, wherein each of the instances of the uplink resources comprise at least a data resource. In step S4, the method comprises determining control information related to the uplink data to be transmitted to the wireless communications network. In step S5, the method comprises transmitting to the wireless communications network, the determined control information related to the uplink data when certain predetermined conditions (e.g. at least one of those described with respect to the example system of FIG. 8) are met. Then, in step S6, the process comprises transmitting to the wireless communications network the uplink data, in at least one of the instances of the uplink resources, where some portion of the data is transmitted in each of the instances of uplink resources that the communications device has scheduled for transmission of the uplink data. The process ends in step S7.

It would be apparent to the skilled person that the process described above is not limiting, and in fact elements not described above may be included in the process without altering the essential characteristics thereof, or elements described above might be amalgamated into a single step, such as transmitting both the control information and the uplink data in a single step of the process, or the steps of the process may occur in an order different to the order presented above. For example, the determining steps S2-4 may happen in any order, or the transmit steps may occur in an opposite order to the order presented above.

These adaptations of the above-described process are presented as examples to illustrate the sort of amendments to the process that might be possible for the skilled person, without departing from the disclosed invention.

UE-based scheduling comprises a control part/control information such as uplink control information (UCI), and a data part. This control part may be embedded in a configured grant resource carried by a physical uplink shared channel, PUSCH, or it may be carried separately in a physical uplink control channel, PUCCH. The data part of the scheduling is, as the skilled person would be aware, typically carried on the PUSCH.

In legacy systems, the control information always accompanies data transmission, that is, whenever the UE transmits signals representing uplink data in the data part to the infrastructure equipment, the UE also transmits control information to the infrastructure equipment either via the PUCCH or the PUSCH.

However, the transmission of the control information represents a constant overhead for the transmissions, and occupies a constant portion of uplink resources in which no uplink signals representing data can be transmitted. Thus, it is an objective of the present disclosure to reduce this constant overhead, so that a greater amount of data may be transmitted to the infrastructure equipment using the same physical resource block. Example embodiments of this proposal are directed towards certain conditions where the control information may be transmitted.

In an example embodiment, if a UE has a large amount of data to transmit to a network, and if a number of channel parameters related to the channel used to transmit the uplink data do not change between instances of uplink transmission, then it is obvious that a UE can continuously transmit the data via the PUSCH on CG resources. By taking advantage of this, a UE could refrain from transmitting control information for a number of these instances of uplink resources when the UE transmits uplink data to the network, and in this way a control overhead for the transmission could be reduced. In other words and in keeping with an example of the present technique, a UE may only transmit the control information related to an uplink transmission instance at a start of the data to be transmitted to the network, at an end of the data to be transmitted to the network, when a resource allocation changes (i.e. a size of a data amount to be transmitted in a particular uplink transmission instance), or when details related to the channel used to transmit the uplink data to the network, such as the modulation and coding scheme use, change.

In order for the network to know scheduling parameters related to the uplink transmission at the beginning of the data transmission (for example a frequency-domain resource allocation, a time-domain resource allocation, a modulation and coding scheme, or a transport block size) a UE must transmit the control information and the data part. Therefore, the start of an uplink transmission is an example of an instance when a UE may transmit the control information in addition to the data part of the transmission.

Another example of an instance when a UE may transmit control information in addition to data to the network is an instance when a resource allocation (i.e. data size) for the UE changes, so that the network is informed of how large a physical resource block the network is required to decode. This is particularly important as extended Reality, XR, along with a number of other future wireless communications applications, has variable data packet sizes.

A further example of an instance when a UE may be required to inform the network is when channel information changes for the channel used to carry signals between the UE and the network. One of the drawbacks of legacy CG is that it does not react to a change of the channel condition due to the relative motion of the UE and the infrastructure equipment to which it transmits signals, location of the UE or a presence of a blockage between the UE and the infrastructure equipment, resulting in sub-optimum performance of the communications in terms of capacity. Hence, dynamically updating the MCS when the channel changes significantly may increase the capacity of the system.

In an example where a communications link between a UE and an infrastructure equipment is based on a time division duplex, TDD, method, the UE already has the channel knowledge as this is possible due to channel reciprocity. In an alternative scenario where FDD is employed instead, the network may periodically, or aperiodically, inform the UE of the MCS, CQI, or channel information related to the channel. Another way that the UE may trigger a change in the MCS or channel that the network monitors is by monitoring feedback such as the HARQ-ACK transmitted to the UE by the network, related to a number of UL transmissions prior to the present instance of communication between the UE and the infrastructure equipment (outer-loop link adaptation).

A final example of when a UE may transmit control information in addition to a data part to the network is when a particular instance of uplink transmission is a final instance of uplink transmission for a particular set of data to be transmitted. This is to inform the network that the UE does not require the resources that are scheduled to it temporarily.

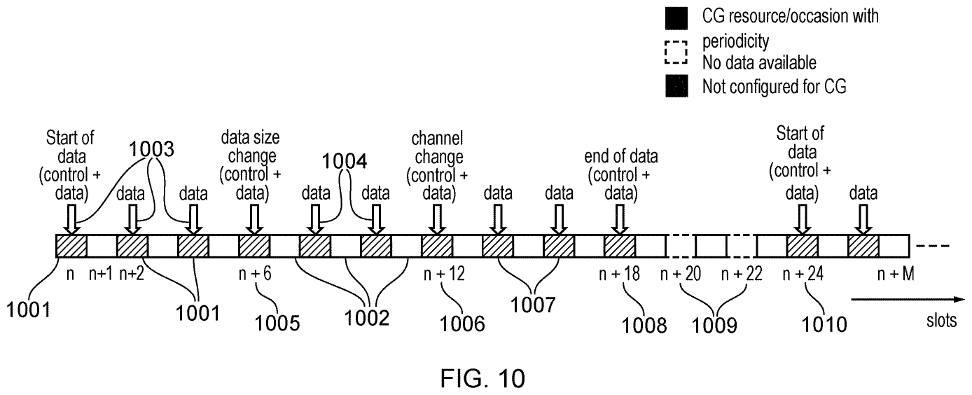

FIG. 10 shows an exemplary embodiment of the present technique, which will be described in greater detail below. FIG. 10 gives a representation of a UE transmitting data to a network in accordance with the present technique. The UE is scheduled with CG resources in even-numbered resources, having a periodicity of every 2nd slot—n, n+2, n+4, n+6 etc.—as indicated by the black squares 1001 of FIG. 10. Between these configured resources are a number of resources that are not configured for transmission of the uplink data from the UE to the network, as indicated by the white squares 1002. Data transmission is indicated by black vertical arrows 803, a size of which indicates an amount of data to be transmitted from the UE to the network. For instance, a large arrow 1004 indicates a greater amount of data to be sent from the UE to the network than a smaller arrow 1003.

At slot n, the UE starts to transmit control information and the data part where, in this example, the control information informs the network about the resource allocation for PUSCH which the UE is utilising to transmit to the network. The UE continues to transmit only the data part in subsequent slots, where the transmission in the said subsequent slots employ the same parameters as the slot representing the start of the transmission. However, at slot n+6 1005, the UE determines that it has additional data to transmit to the network in order to maintain the throughput and/or latency of the data. Hence, the UE allocates more resources for the uplink transmission of this data, and includes in the control information a new resource allocation containing more resources. This control information is transmitted to the network, since in this example of the size of data resources changing from slot n+4 801 to slot n+6 1005 a predetermined condition for the UE to transmit control information is met. Therefore, the UE transmits both control information and data part to the network in slot n+6 1005. In an alternative embodiment, the UE may transmit control information to the network to be implemented in the next slot, e.g. may transmit control information with the transmission at slot n+4 1001 so that the network is prepared for a larger allocation of data resources for a transmission in slot n+6 1005. The UE continues to transmit only the data part to the network in the subsequent resources with the same parameters as the last control transmission (slots n+8 and n+10, not labelled).

However, at slot n+12, 1006, the UE determines that one or more certain parameters related to the channel have changed. For example, the UE may have received a NACK from the network in response to a previous transmission instance, the UE may have been informed by the network of changes to the channel such as a decrease in the SNR corresponding to the channel or other appropriate parameters related to the channel, or the UE may determine the change in the certain parameters via channel reciprocity and a measurement conducted on downlink communications. The skilled person would understand that the above is provided as exemplary methods by which the UE may determine a channel alteration, and is not intended to be limiting. Other suitable methods by which the UE may determine this can be conceived and implemented in line with the present disclosure.

In response to determining this change in one or more parameters related to the channel, the UE may determine that it has to update the modulation and coding scheme used by the UE for uplink transmissions. Alternatively, other changes might be made by the UE in order to improve the reception of the signals at the network side. In view of this determining, the UE then changes the MCS employed, and includes in the uplink transmission both a data part and control information, where the control information includes updated details related to the MCS used by the UE, in particular, details which allow the network to successfully decode the signals transmitted by the UE to the infrastructure equipment. As above, in subsequent slots n+14 and n+16, 1007, the UE transmits only the data part, since control information for these slots is the same as control information for the slot n+12 1006.

At slot n+18, 1008, the UE determines that there is enough resources in the slot n+18 1008 to transmit a remainder of the data to be transmitted to the network. In other words, the UE determines that a transmission of data in slot n+18 1008 will be a final transmission of data for this set of data, and that the data to be transmitted in slot n+18 1008 is last data. In response to this, the UE informs the network that the data transmitted in slot n+18 1008 is last data, or final data. In some example embodiments, this informing the network may be done by including in control information an indication that the data to be transmitted is last data, and including, by the UE, the control information in the transmission to the network along with the data part. In other example embodiments, the UE may signal this in a penultimate uplink resource, such as in this example slot n+16 1007, so that the network is informed of the final transmission before receiving it. In yet further example embodiments, the UE may indicate to the network that a transmission is a final transmission by transmitting no control information or data part to the network in a next periodic uplink resource, or by skipping the uplink resource, and so no DMRS is detected by the infrastructure equipment. This allows the network to schedule the resources to another communications device or devices if needed and is not expected to cause interference since the UE has no data to transmit to the network.

This is the case in slots n+20 and n+22, 1009, where the outline of the box in FIG. 10 is changed to a dashed line to indicate, as per the key in FIG. 10, that there is no available data to transmit. The UE thus does not transmit on these slots, and the network may choose to schedule them for another communications device to perform uplink communications to the network.

In slot n+24, 1010, the UE has data to transmit to the network. It therefore proceeds by the same process as described above. In particular, and with reference to the particular instance of transmission in slot n+24, 1010, this transmission is a first transmission to the network, in other words a start of transmission of data to the network, and so the UE determines that it must include in the transmission both a data part and control information related to the data part of the uplink transmission. Thus, the UE transmits control information to the network to allow the network to decode the uplink transmission, and proceeds in a similar process as detailed above.

In one embodiment, if an amount of data is only enough for a single instance of data transmission, the UE may include both an indication that the transmission is a first transmission related to this data in the control information and an indication that the transmission is a final transmission related to this data in the control information. The UE transmits control information in addition to a data part, and transmits the data part in accordance with the control information transmitted to the network.

In another embodiment, in an amount of data is only enough for a single instance of data transmission, the UE may include an indication that the transmission is a final transmission related to this data in the control information and not include an indication that the transmission is a first transmission related to this data in the control information. In this way, the network may be able to infer from the transmission that the data is a first transmission related to this data, and the corresponding communication overhead may be reduced.

In each uplink resource instance, the network, and in particular an infrastructure equipment, monitors the interface and, on receiving a transmission, checks if control information is present. If control information is present, the network processes the data part of the transmission in accordance with the control information. If no control information is present, the network assumes the control information has not changed since a prior instance of uplink communication, and processes the transmission in accordance with control information from the prior instance of uplink communication. The network may generate a negative acknowledgement if it cannot decode a transmission on the PUSCH based on the last received control information, and if it has not received an indication that it has received the end of the data to be transmitted to it, i.e. a “final data” indication.

The advantage of this is that a control overhead is significantly reduced, thereby allowing greater data transmission and increasing the capacity of the system without a change in the PRB used by the system. Another advantage is that only a single CG resource with realistic periodicity would be enough for an XR application, since the size of the resource allocation, along with a number of its other parameters, can be dynamically updated. This is instead of the legacy configuration, where a plurality of different sets of transmission resources and parameters are required, in order to handle the adaptation of the configuration and parameters, thus consuming many resources.

### Dynamic Adaptation of CG Transmission Parameters

There are a plurality of transmission parameters that can be adapted instantaneously for CG PUSCH by the UE through the control information transmitted to the network. These transmission parameters may be changed, for example, based on the channel conditions as indicated by channel parameters, or based on other impairments.

A first transmission parameter that may be adapted is a configuration of symbols, in an example of TDD communication. As the skilled person understands, for TDD communication a slot format is an arrangement of OFDM symbols in a slot, where each OFDM symbol (also hereafter referred to as simply a “symbol”) can be configured as Downlink (DL), Uplink (UL), or Flexible (FL). In a legacy configuration, a UE receives control information and/or data only in the DL symbols, and transmits control information and/or data to the network only in the UL symbols of the slot. The network is able to determine whether the FL symbols should be used for uplink or downlink communication, and indicates from the infrastructure equipment to the UE a change in the slot format. In this way, FL symbols can be indicated for use in the DL or UL in the same slot.

However, currently, a UE cannot determine to change a configuration of a symbol designated FL to UL if the UE has more data to transmit to the network in the uplink direction, and must wait for the network to change the slot format. It is here suggested that a UE could include in its control information an indication of an alteration to a slot format for a slot, whereby a UE can indicate a change of a FL symbol to a UL symbol when the UE determines it as being advantageous to the UE. This change may be applicable only to the current slot, or may be applicable to future slots of a radio frame also. This indication may be carried in the uplink channel indication, UCI, or via the PUCCH channel.

Another transmission parameter that may be included by the UE in control information is related to frequency hopping. In a legacy system, such as NR, frequency hopping is configured and enabled by a network and/or an infrastructure equipment, and, as with slot formats discussed above, the UE has to follow commands from the network in relation to this. Therefore, the UE is not able to determine whether to use frequency hopping for PUSCH transmissions.

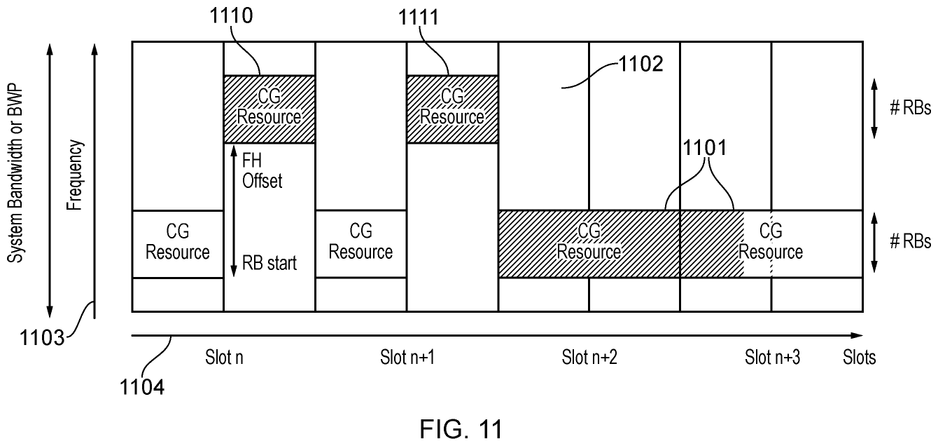

As discussed above, in keeping with example embodiments of the present technique a UE is able to determine transmission parameters for its communication with a network via CG PUSCH, and hence the UE can enable or disable frequency hopping for each transmission autonomously. An example of this is depicted in FIG. 11.

FIG. 11 provides a graphical representation of uplink resources used by a UE to transmit to the network, the uplink resources utilised by the UE 1101 pictured in a darker colour than transmission resources not used 1102 by the UE. These are shown graphically, with frequency as a vertical axis 1103 and time measured in slots as a horizontal axis 1104. In a latter half 1110 of slot n and in a latter half 1111 of slot n+1, the UE employs frequency hopping due to poor channel conditions and or interferences where a PUSCH resource is divided into two hops; lower and upper parts. In this case, a transport block (TB) is mapped to both parts of the resource, although they are separated in frequency domain. A frequency hop offset is determined by the UE. Subsequently, the UE continues to enable and apply frequency hopping in slot n+1. However, in slots n+2 and n+3 the UE disables frequency hopping due to better channel conditions, fewer interferences or other details as determined by the UE. In order to inform the network of parameters related to frequency hopping employed by the UE, the UE may include in control information a flag bit that provides an indication of whether the UE has enabled or disabled frequency hopping. If needed, the UE may also include in control information an indication of a frequency hopping offset, an indication of a number of frequency hopping instances, and an indication of to which of the instances of uplink resources the frequency hopping applies. As described above, these indications and parameters related to frequency hopping included in the control information may be transmitted in the UCI or via the PUCCH.

A further parameter which the UE might control to improve transmission and reception of signals at the infrastructure equipment is a waveform for PUSCH. As the skilled person would be aware, NR supports two waveforms in the uplink: Cyclic Prefix-Orthogonal Frequency Division Multiplexing, CP-OFDM, and Discrete Fourier Transform-spread-Orthogonal Frequency Division Multiplexing, DFT-s-OFDM. CP-OFDM has an increased throughput and capacity in comparison, and DFT-s-OFDM provides improved UL coverage when a UE is at a cell-edge. Therefore, it is disclosed here in keeping with an embodiment of the present technique that the UE can choose autonomously, that is, independently of the network, which of the two supported waveforms to use. An indication of the preferred waveform is included by the UE in the control information and transmitted to the infrastructure equipment either by the UCI or via the PUCCH channel.

Another parameter that might be controlled independently by the UE is a DMRS configuration type. NR supports two types of DMRS pattern, known as Type 1 and Type 2. DMRS configuration type 1 has a higher density of DMRS resources in terms of a number of resource elements included in the DMRS, and provides a more reliable connection when a UE experiences poor channel conditions or has high-speed mobility. In contrast, DMRS type 2 has a lower density of DMRS resources (fewer number of DMRS resources), and consequently the overhead is reduced, which is advantageous in good channel conditions when the transmission of signals between the UE and the infrastructure equipment is reliable. As the conditions of the channel change instantaneously, the present disclosure allows the UE to choose the DMRS configuration type dynamically; an indication of the choice being included in the UCI or the PUCCH channel to be transmitted to the network.

A further parameter that the UE might decide to control is DMRS length. In NR, single and double “OFDM symbol” DMRS configurations are supported. The purpose of the double symbol configuration is to increase the multiplexing capacity of the antenna ports. In a case of a single symbol configuration, up to six antenna ports may be supported, whilst in the double symbol configuration up to 12 antenna ports can be supported. One of the benefits of the double symbol configuration is that up to 12 UEs can be supported in a MU-MIMO manner. To this end, the UE includes in the control information that it sends to the network an indication of whether its transmission is a single or double DMRS length configuration, for instance by including a flag bit where one setting of the flag bit indicates a single symbol configuration, and another setting of the flag bit indicates a double symbol configuration.

Yet another parameter is an additional DMRS configuration of resources. In the legacy system, in order to improve the channel estimation for PUSCH at the infrastructure equipment, additional DMRS resources can be configured for a UE. Whilst this provides performance gains from channel estimation when a UE is in poor channel conditions and/or in high-speed mobility, it also increases the DMRS overhead required to be transmitted, potentially increasing interference and using additional resources of the interface. Since the channel conditions may change instantaneously, it is important to reduce the DMRS overhead when higher density DMRS are not required, and thus the UE may include in the control information transmitted to the network an indication related to additional DMRS resources. This indication, along with the resource chosen by the UE over which to transmit the additional DMRS information, can be decided by the UE dynamically and independently of the network. This indication may relate to the additional DMRS resources in the sense of indicating their presence, and/or it may relate to the additional DMRS resources in the sense of providing an indication of the location of the additional DMRS resources. The indication of a presence of additional DMRS can be included in the UCI or PUCCH channel.

Another parameter that the UE might control by providing an indication to the network regarding is the PUSCH mapping type employed by the UE. As will be familiar to the skilled person, NR supports two types of PUSCH mapping scheme, commonly referred to as Type A and Type B. Type A is normally used for large allocations of data, where the resource allocation in time may span all OFDM symbols in a slot, for example up to 14 symbols. In this case, where all symbols are allocated, the allocation always starts from the first symbol (index 0) and the minimum allocation is 4 symbols. The DMRS is located, in this case, in either the 2nd or 3rd OFDM symbol of the slot. On the other hand, PUSCH mapping type B is intended for smaller allocations known as mini-slots where resource allocation in time spans only a few OFDM symbols in the slot, for example 2, 4, or 7 symbols, although this is not limiting and other lengths of allocation may be employed. In Type B, the DMRS is located on the first symbol of the resource allocation, known as “Front loaded DMRS”. As the name implies, the DMRS is in the first slot of the PUSCH allocation in order to provide fast channel estimations or to reduce the decoding latency. The indication of PUSCH mapping type A or type B transmitted from the UE to the network can be included in the UCI or the PUCCH channel.

An alternative parameter that may be controlled by the UE related to uplink communications is how control information may be included in the PUSCH channel. For instance, a hybrid automatic repeat request, HARQ-ACK, a scheduling request, SR, channel state information, CSI, such as a channel quality indicator CQI, precoding matrix indicator, PMI, or rank indicator RI may be included and multiplexed in PUSCH. The UE may determine to indicate whether the control information is included in the PUSCH so that the infrastructure equipment can detect and perform fast processing on the control information before decoding the data. In yet a further embodiment, the UE may indicate to the network whether the PUSCH carries only control information, and that no data is available for transmission.

In a separate embodiment of the present technique, the UE may transmit as part of the control information an indication of a power-level ratio between UCI and PUSCH data transmissions. That is, the UE can include in the control information some indication of the difference between and the ratio of the transmission powers of the UCI transmission and the PUSCH transmissions, which the UE transmits to the network as part of the uplink communication. The UE then transmits to the network the control information and data part of the transmission in accordance with the power-level ratio.

A UE may also control the number of multiple input multiple output, MIMO, layers used in PUSCH transmission, in a dynamic and autonomous manner; that is, without input of the network. An indication of the number of MIMO layers used may be included by the UE in the control information and transmitted to the network, via either the UCI or the PUCCH channel, and the UE subsequently performs communication with the network in a manner according to the indication that it transmits to the network.

### Fairness Request from Neighbouring Cells

One of the challenges of heavy, or high capacity, uplink is the impact on other cells in terms of interference. In other words, the uplink transmission of data and control information can cause interference in other neighbouring cells, particularly if the uplink transmission is of a large amount of data, as would be the case for heavy uplink transmission. If the uplink beam is well controlled at the transmission side by the UE (the beam from the UE to the infrastructure equipment is well controlled, or narrow), then the interference caused in other cells is limited and may be considered generally to be low.

In general, this control at the UE is not possible, due to the number of antenna elements at the UE being low, and thus the control achievable on the UE uplink beam is reduced. The beam then from the UE to the infrastructure equipment is therefore typically quite wide, and interference is seen. This is exacerbated, often, if the beam from the UE can move and/or rotate in a flexible manner. In view of this, the following procedure provides a method and apparatus for addressing this issue, and describes how neighbour cells can initiate a fairness request when there is an unacceptable level of uplink interference from the uplink transmission of the UE.

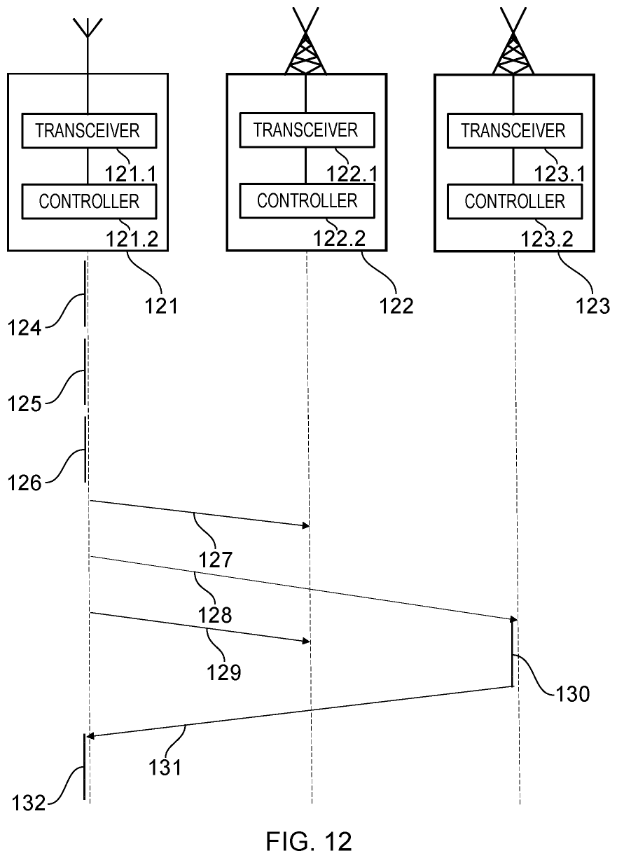

This is described with reference to exemplary embodiment FIG. 12. FIG. 12 depicts a configuration of communicatively connected devices and a message flow thereof; neither the configuration of the devices nor the order and number of messages is limiting as other elements of the devices may be necessary for their function, and other message flows may be implemented to achieve the same effect. FIG. 12 depicts communications device 121, an infrastructure equipment 122 which serves the communications device 121, that is the infrastructure equipment 122 provides connectivity for at least the communications device 121 inside a cell provided by the infrastructure equipment 122, and a separate infrastructure equipment 123 which provides connectivity related to a different cell. Communications device 121 is formed of at least a transceiver, 121.1, and a controller 121.2. Likewise, infrastructure equipment 122 and 123 are each formed of at least a transceiver 122.1 and 123.1, and a controller 122.2 and 123.2. Of course, other elements of these apparatuses may be necessary for their operation, and the skilled person would understand to implement these with additional elements such as for example a memory to store instructions, an input/output element, and a display.

In an exemplary first step 124, the communications device 121 determines that it has uplink data to transmit to the wireless communications network. The communications device 121 is connected to the wireless communications network via the infrastructure equipment 122 that supports it.

In a further exemplary second step 125, the communications device 121 determines a plurality of uplink resources that the communications device may use for the transmission of the uplink data determined in the previous step 124 to the wireless communications network. These resources are seen to be periodically occurring instances of uplink resources, and it is understood that although an infinite number may be indicated by the periodicity (every second slot, for example), the communications device will need only a subset of these resources to transmit the uplink data that it has to transmit. Therefore, it is envisaged that the communications device 121 will only schedule transmission for a subset of the periodically occurring instances of uplink resources. The uplink resources contain at least a data resource, where uplink data may be included, and may in addition contain a control resource, where control information may be included.

Similarly, in a third step 126, the communications device 121 determines control information related to the uplink data already determined. As described above, control information may indicate a number of parameters regarding the uplink data, such as the PRB used to transmit it, a modulation and coding scheme used to encode the uplink data, or other such details. In a fourth step 127, the communications device 121 transmits to the wireless network the control information related to the uplink data via the infrastructure equipment 122 that serves the communications device 121.

In a fifth step 128, the communications device 121 transmits the control information determined to a second infrastructure equipment 123. In this case, the communications device 121 is able to connect to two cells/TRPs simultaneously, as the communications device 121 does not release its connection with a first infrastructure equipment 122 when transmitting to the second infrastructure equipment 123. In other words, the communications device 121 informs neighbouring cells of the uplink transmission which it has scheduled for transmitting uplink data to the infrastructure equipment 122. This may be achieved in a number of ways, and FIG. 12 is one example of this. Another procedure might transmit the control information from the communications device 121 to the infrastructure equipment 122, and then have the infrastructure equipment 122 transmit the control information to the second infrastructure equipment 123. In either case, and in other embodiments as the skilled person would be able to conceive, the second infrastructure equipment 123 receives the control information and is informed of the uplink transmission that the UE is undertaking. The fifth step 128 may be optional, and instead the first infrastructure equipment 122 may forward the control information as received from the communications device 121 in the third step 126 to the second infrastructure equipment 123. Within this control information, the communications device 121 may include location information related to the communications device 121, which the second infrastructure equipment 123 may use in later steps.

In a sixth step 129, the communications device 121 begins transmitting to the infrastructure equipment 122 the uplink data that it has determined should be transmitted, and uses the uplink resources that were determined for the transmission of said data. This transmission uses interface resources, and inevitably causes some level of interference in neighbouring cells.

In a seventh step 130, the second infrastructure equipment 123 monitors interference measured in the cell that it serves. It may do this by measuring the reception of the signals from the communications device 121, or it may do this be measuring the effect on transmissions (not shown) that it exchanges with communications devices in its cell, for instance measuring the RSRP for these transmissions or other indicators of the interference present in the interface. It compares this level of interference with a predetermined threshold for interference to determine whether the level of interference caused by the uplink transmission of the communications device 121 is unacceptable. The second infrastructure equipment may use the location information related to the communications device 121 in this step, or it may monitor the interference without reference to the location of the communications device 121.

In an eighth step 131, the second infrastructure equipment 123 provides feedback to the communications device 121 as to the level of interference experienced in the neighbouring cell. This feedback may be explicit, for example in the form of a fairness request indicating that the level of interference in the neighbouring cell is unacceptable, or it may be implicit, in the form of no fairness request, which implies that the level of interference experienced in the neighbouring cell is acceptable. Further, although FIG. 12 depicts this feedback as a transmission from the second infrastructure equipment 123 to the communications device 121, which the second infrastructure equipment 123 may use the location information related to the communications device 121 to establish, other methods of providing this may be implemented by the skilled person. For example, the second infrastructure equipment 123 may indicate to the infrastructure equipment 122 the feedback, which the infrastructure equipment 122 then transmits to the communications device 121.

Finally, in receipt of the feedback, the communications device 121 adapts the transmission of the uplink data to the infrastructure equipment 122. This adaptation may be the reduction in a transmission rate (increasing the periodicity of the uplink resources used by the communications device 121 to transmit to the infrastructure equipment 122), decreasing the power supplied to the transceiver for transmitting to the infrastructure equipment, or ceasing to transmit to the infrastructure equipment. Alternatively, if the feedback is that the level of interference in a neighbouring cell is acceptable, the adaptation of the transmission to the infrastructure equipment may not correspond to the actions described above, in order to reduce the interference in a neighbouring cell. The adaptation may involve performing no changes to the schedule and power of the transmission.

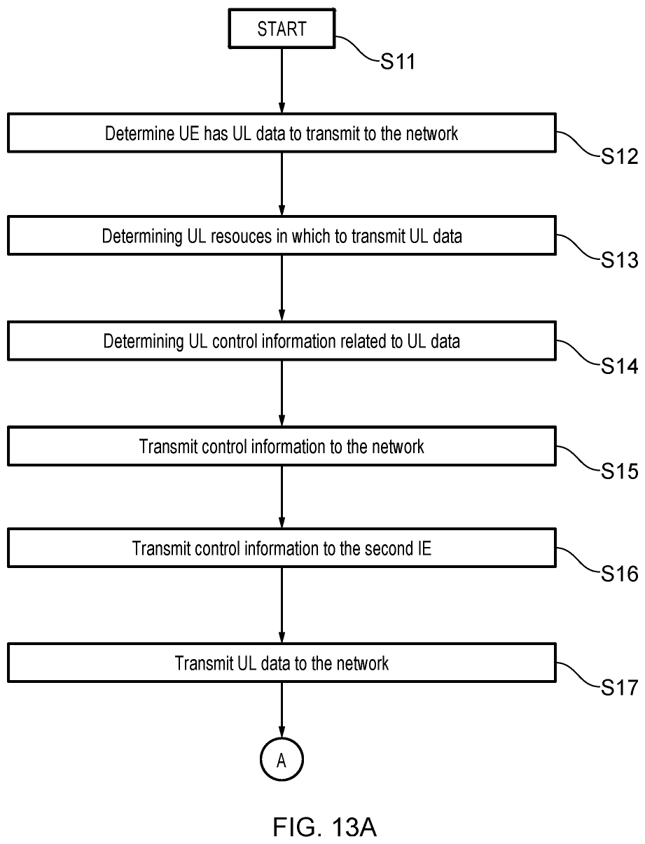

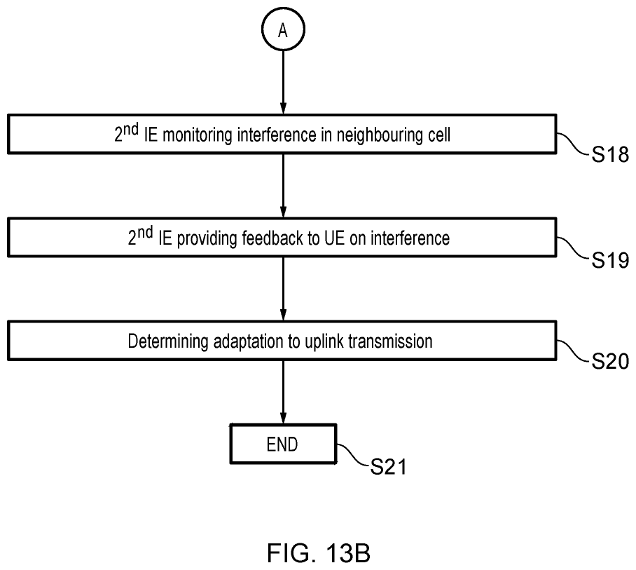

FIGS. 13A and 13B show a flow diagram illustrating an example process of communications in a communications system in accordance with embodiments of the present technique. The process shown by FIGS. 13A and 13B is a method of operating a communications device (such as communications device 121 of the example system of FIG. 12) configured to transmit signals to and/or to receive signals from a wireless communications network (e.g. to or from an infrastructure equipment of the wireless communications network), the communications device operating in accordance with a communications device based scheduling mode in order to transmit uplink data.

The method begins in step S11. The method comprises, in step S12, determining that the communications device has uplink data to transmit to the wireless communications network. In step S13, the process comprises determining, independently from the wireless communications network, a plurality of periodically occurring instances of uplink resources of the wireless access interface in which the uplink data is to be transmitted, wherein each of the instances of the uplink resources comprise at least a data resource. In step S14, the method comprises determining control information related to the uplink data to be transmitted to the wireless communications network. In step S15, the method comprises transmitting to the wireless communications network, the control information related to the uplink data. Then, in step S16, the process comprises transmitting to a second infrastructure equipment, the control information related to the uplink data, so that the second infrastructure equipment is able to monitor for interference in a neighbouring cell arising from the uplink data transmission. Then, in step S17, the method comprises transmitting to the wireless communications network the uplink data, in at least one of the instances of the uplink resources. The process then continues to FIG. 13B from FIG. 13A, where point A is identical in both FIGS. 13A and 13B and indicates a continuation of the method.

Next, in FIG. 13B, step S18 comprises the second infrastructure equipment, which has received the control information from the communications device, monitoring for interference from the uplink transmissions of the communications device. As part of this monitoring, the second infrastructure equipment also compares the level of interference measured with a predetermined threshold of interference. Then, in step S19, the second infrastructure equipment provides feedback to the communications device either explicitly or implicitly regarding the level of interference and/or whether it exceeded the predetermined threshold, which may take the form of a fairness request. In response to receiving this feedback (e.g. a fairness request), the communications device adapts the transmission of the uplink data to the wireless communications network, in step S20. The process ends at step S21.

In other embodiments, roles in the communication process that are played by the communications device and the infrastructure equipment may be reversed. In other words, it may be that in an embodiment an infrastructure equipment is transmitting downlink signals representing data to a communications device, and it may provide to neighbouring cells control information related to the downlink signals that are transmitted, when certain predetermined conditions are met such as a change in the resource used by the infrastructure equipment, the modulation and coding scheme, or at the start or end of the transmission to name just four such examples. As indicated above in an uplink embodiment, other conditions may be conceived, and other information may be included in the control information.

On receiving this control information, either directly from the infrastructure equipment or relayed via a second infrastructure equipment, a second communications device may monitor interference in a cell, and may provide feedback to the infrastructure equipment as to the level of the interference observed by the communications device. This feedback, again, may comprise a fairness request or indication of the interference level, or whether the interference exceeds a predetermined threshold. On receiving the feedback from the communications device, the infrastructure equipment may adapt the transmission of the downlink signals.

In embodiments where the communications device is to communicate with the second infrastructure equipment, it may be configured to do so. This ability of the communications device to communicate with a second, i.e. not the serving, infrastructure equipment, may be based on one or more of carrier aggregation/dual connectivity, Dual Active Protocol Stack, DAPS, handover, a conditional handover where the communications device knows a configuration of a second cell corresponding to the second infrastructure equipment, or L1/L2 mobility where a beam configuration of the second cell is known to the UE. In other example embodiments, any communication between the communications device and the second infrastructure equipment may pass via the first infrastructure equipment, which may reduce complexity of the communications device since it only needs to be capable of communicating with the infrastructure equipment that serves it.

Those skilled in the art would appreciate that the method shown by FIGS. 13A and 13B may be adapted in accordance with embodiments of the present technique. For example, other intermediate steps may be included in this method, or the steps may be performed in any logical order. Though embodiments of the present technique have been described largely by way of the example communications system shown in FIG. 8, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

### [Paragraph 1]

A communications device for operation in a wireless communications network, the communications device comprising
a transceiver, configured to transmit signals to and/or receive signals from an infrastructure equipment forming part of the wireless communications network via a wireless access interface provided by the wireless communications network, the signals representing data,
a controller, configured to control the transceiver, and
a memory storing instructions which when executed by the controller cause the communications device to
determine that the communications device has uplink data to transmit to the wireless communications network,
determine a plurality of periodically occurring instances of uplink resources of the wireless access interface in which the uplink data is to be transmitted, the uplink resources comprising at least a data resource,
determine, independently from the wireless communications network, control information related to the uplink data,
transmit to the wireless communications network the determined control information for a particular one of the instances of uplink resources if a predetermined condition is met, wherein the predetermined condition is at least one of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink resources, and a modulation and coding scheme encoding the uplink data to be transmitted in the particular instance of uplink resources is different to a modulation and coding scheme used to encode uplink data transmitted in a previous instance of uplink resources, and
transmit the uplink data to the wireless communications network via the data resource in each of the plurality of instances of uplink resources.

### [Paragraph 2]

The communications device of paragraph 1, wherein, if the data resource corresponding to a particular instance of uplink resources is sufficient for the transmission of all the uplink data to be transmitted, the communications device includes in the control information an indication that the uplink data to be transmitted in the particular instance of uplink resources is a start of the uplink data to be transmitted and an indication that the uplink data to be transmitted in the particular instance of uplink resources is an end of the uplink data to be transmitted.

### [Paragraph 3]

The communications device of paragraph 1, wherein, if the data resource corresponding to a particular instance of uplink resources is sufficient for the transmission of all the uplink data to be transmitted, the communications device includes in the control information an indication that the uplink data to be transmitted in the particular instance of uplink resources is an end of the uplink data to be transmitted and does not include in the control information an indication that the uplink data to be transmitted in the particular instance of uplink resources is a start of the uplink data to be transmitted.

### [Paragraph 4]

The communications device of paragraph 1, wherein an indication that the uplink data to be transmitted in the particular instance of uplink resources is an end of the uplink data to be transmitted is implicitly indicated to the wireless communications network by the communications device not transmitting uplink data in a next determined instance of uplink resources.

### [Paragraph 5]

The communications device of any preceding paragraph, wherein the wireless access interface uses a time division duplex method of multiplexing signals, and
wherein the instructions which when executed by the controller further cause the communications device to
determine at least one OFDM symbol configured by the wireless communications network as a flexible OFDM symbol,
determine that the communications device has more uplink data to transmit to the wireless communications network,
transmit to the wireless communications network as part of the control information an indication to change a configuration of the at least one OFDM symbol from a flexible OFDM symbol to an uplink OFDM symbol, and
transmit to the wireless communications network, via the at least one OFDM symbol, at least one symbol representing uplink data.

### [Paragraph 6]

The communications device of any preceding paragraph, wherein the communications device transmits to the wireless communications network as part of the control information at least one parameter related to frequency hopping, and transmits the control information and uplink data to the wireless communications network in accordance with the at least one parameter related to frequency hopping.

### [Paragraph 7]

The communications device of paragraph 6, wherein the at least one parameter related to frequency hopping includes at least one of a frequency hopping flag bit, an indication of a number of frequency hops, an indication of a frequency hopping offset, and an indication of to which particular instance or instances of uplink resources the at least one parameter relates.

### [Paragraph 8]

The communications device of any preceding paragraph, wherein the communications device transmits to the wireless communications network as part of the control information an indication of a waveform and the communications device transmits the control information and/or uplink data to the wireless communications network in accordance with the indication of a waveform.

### [Paragraph 9]

The communications device of paragraph 8, wherein the indication of a waveform is an indication of one of a CP-OFDM waveform or a DFT-s-OFDM or SC-OFDM waveform.

### [Paragraph 10]

The communications device of any preceding paragraph, wherein the communications device transmits to the wireless communications network as part of the control information an indication of a DMRS configuration, comprising an indication of a first DMRS configuration or an indication of a second DMRS configuration, and the communications device transmits the control information and uplink data to the wireless communications network in accordance with the indication of a DMRS configuration.

[paragraph 11]

The communications device of any preceding paragraph, wherein the communications device transmits to the wireless communications network as part of the control information an indication of a DMRS length and the communications device transmits the control information and uplink data to the wireless communications network in accordance with the indication of a DMRS length.

### [Paragraph 12]

The communications device of any preceding paragraph, wherein the communications device transmits to the wireless communications network as part of the control information an indication related to additional DMRS resources and the communications device transmits the control information and uplink data to the wireless communications network in accordance with the indication of additional DMRS resources.

### [Paragraph 13]

The communications device of any preceding paragraph, wherein the communications device transmits to the wireless communications network as part of the control information an indication of a PUSCH mapping scheme and the communications device transmits the control information and uplink data to the wireless communications network in accordance with the indication of a PUSCH mapping scheme.

### [Paragraph 14]

The communications device of any preceding paragraph, wherein the communications device transmits to the wireless communications network as part of the control information an indication that control information is included in a PUSCH channel and the communications device transmits the control information and uplink data to the wireless communications network in accordance with the indication that control information is included in the PUSCH channel.

### [Paragraph 15]

The communications device of any preceding paragraph, wherein the communications device transmits to the wireless communications network as part of the control information an indication that the communications device includes, in the PUSCH channel, control information only, and the communications device transmits the control information to the wireless communications network in accordance with the indication that the communications device includes in the PUSCH channel control information only.

### [Paragraph 16]

The communications device of any preceding paragraph, wherein the communications device transmits to the wireless communications network as part of the control information an indication of a ratio of transmission power between a transmission of uplink control information, UCI, and PUSCH transmissions, and the communications device transmits the control information and uplink data to the wireless communications network in accordance with the indication of a ratio of transmission power between uplink control information, UCI, and PUSCH transmissions.

### [Paragraph 17]

The communications device of any preceding paragraph, wherein the communications device transmits to the wireless communications network as part of the control information an indication of a number of multiple input multiple output, MIMO, layers for PUSCH transmission, and the communications device transmits the control information and/or uplink data to the wireless communications network in accordance with the indication of a number of MIMO layers for PUSCH transmission.

### [Paragraph 18]

The communications device of paragraph 1, wherein the instructions executed by the controller cause the communications device to further receive from the wireless communications network an indication of at least one of a coding scheme to be used to encode uplink data and/or control information to be sent to the wireless communications network, a channel quality indicator related to a channel via which the uplink data and/or the control information is to be sent, or a change of a channel to be used to send uplink data and/or control information to the wireless communications network, and
to transmit to the wireless communications network uplink data and/or control information in accordance with the indication received from the wireless communications network.

### [Paragraph 19]

Circuitry for a communications device for operation in a wireless communications network, the communications device comprising
transceiver circuitry, configured to transmit signals to and/or receive signals from an infrastructure equipment forming part of the wireless communications network via a wireless access interface provided by the wireless communications network, the signals representing data,
controller circuitry, configured to control the transceiver circuitry, and
memory circuitry storing instructions which when executed by the controller circuitry cause the communications device to
determine that the communications device has uplink data to transmit to the wireless communications network,
determine a plurality of periodically occurring instances of uplink resources of the wireless access interface in which the uplink data is to be transmitted, the uplink resources comprising at least a data resource,
determine, independently from the wireless communications network, control information related to the uplink data,
transmit the determined control information for a particular instance of uplink resources if a predetermined condition is met, wherein the predetermined condition is at least one of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink data transmission, and a coding scheme encoding the uplink data to be transmitted in the particular instance of uplink resources is different to a coding scheme used to encode uplink data in a previous instance of uplink data transmission, and
transmit the uplink data to the wireless communications network via the data resource.

### [Paragraph 20]

A method of operating a communications device configured to transmit signals to and/or receive signals from a wireless communications network via a wireless access interface provided by the wireless communications network, the method comprising
determining that the communications device has uplink data to transmit to the wireless communications network,
determining a plurality of periodically occurring instances of uplink resources of the wireless access interface in which the uplink data is to be transmitted, the uplink resources comprising at least a data resource,
determining, independently from the wireless communications network, control information related to the uplink data,
transmitting the determined control information for a particular instance of uplink resources if a predetermined condition is met, wherein the predetermined condition is at least one of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink data transmission, and a coding scheme encoding the uplink data to be transmitted in the particular instance of uplink resources is different to a coding scheme used to encode uplink data in a previous instance of uplink data transmission, and
transmitting the uplink data to the wireless communications network via the data resource.

### [Paragraph 21]

An infrastructure equipment for operation in a wireless communications network, the infrastructure equipment comprising
a transceiver, configured to transmit signals to and/or receive signals from a communications device in the wireless communications network via a wireless access interface provided by the wireless communications network, the signals representing data,
a controller, configured to control the transceiver,
a memory storing instructions which when executed by the controller cause the infrastructure equipment to
receive control information transmitted from the communications device in a particular instance of periodically occurring uplink resources of the wireless access interface,
receive uplink data transmitted from the communications device in a particular instance of uplink resources, the particular instance of uplink resources being a corresponding particular instance of uplink resources to the particular instance of uplink resources carrying the control information, or a particular instance of uplink resources later than a corresponding particular instance of uplink resources to the particular instance of uplink resources carrying the control information,
decode the uplink data transmitted from the communications device in accordance with the control information received from the communications device.

### [Paragraph 22]

The infrastructure equipment of paragraph 20, wherein the instructions executed by the controller cause the infrastructure equipment further to
transmit to the communications device an indication of at least one of a coding scheme to be used to encode uplink data and/or control information to be sent to the wireless communications network, a channel quality indicator related to a channel via which the uplink data and/or the control information is to be sent, or a change of a channel to be used to send uplink data and/or control information to the wireless communications network.

### [Paragraph 23]

Circuitry for an infrastructure equipment for operation in a wireless communications network, the infrastructure equipment comprising
transceiver circuitry, configured to transmit signals to and/or receive signals from a communications device in the wireless communications network via a wireless access interface provided by the wireless communications network, the signals representing data,
controller circuitry, configured to control the transceiver circuitry,
a memory storing instructions which when executed by the controller circuitry cause the infrastructure equipment to
receive control information transmitted from the communications device in a particular instance of periodically occurring uplink resources of the wireless access interface,
receive uplink data transmitted from the communications device in a particular instance of uplink resources, the particular instance of uplink resources being a corresponding particular instance of uplink resources to the particular instance of uplink resources carrying the control information, or a particular instance of uplink resources later than a corresponding particular instance of uplink resources to the particular instance of uplink resources carrying the control information,
decode the uplink data transmitted from the communications device in accordance with the control information received from the communications device.

### [Paragraph 24]

A method of operating an infrastructure equipment forming part of a wireless communications network, the infrastructure equipment being configured to transmit signals to and/or receive signals from a communications device via a wireless access interface provided by the infrastructure equipment, the method comprising
receiving control information transmitted from the communications device in a particular instance of periodically occurring uplink resources of the wireless access interface,
receiving uplink data transmitted from the communications device in a particular instance of uplink resources, the particular instance of uplink resources being a corresponding particular instance of uplink resources to the particular instance of uplink resources carrying the control information, or a particular instance of uplink resources later than a corresponding particular instance of uplink resources to the particular instance of uplink resources carrying the control information,
decoding the uplink data transmitted from the communications device in accordance with the control information received from the communications device.

### [Paragraph 25]

A wireless communications system comprising a communications device according to paragraph 1 and an infrastructure equipment according to paragraph 21 or 22.

### [Paragraph 26]

A computer programme comprising instructions which, when loaded onto a computer, cause the computer to perform a method according to paragraph 20 or paragraph 24.

### [Paragraph 27]

A non-transitory computer-readable storage medium storing a computer programme according to paragraph 26.

### [Paragraph 28]

A method of operating a first communications device configured to transmit signals to and/or receive signals from a first infrastructure equipment forming part of a wireless communications network via a wireless access interface provided by the wireless communications network, the method comprising
determining that the communication device has uplink data to transmit to the wireless communications network,
determining a plurality of periodically occurring instances of uplink resources of the wireless access interface in which the uplink data is to be transmitted, the uplink resources comprising at least a data resource,
determining, independently from the wireless communications network, control information related to the uplink data,
transmitting to the wireless communications network the determined control information for a particular instance of uplink resources,
transmitting the uplink data to the wireless communications network via the data resource of the particular instance of uplink resources,
receiving from a second infrastructure equipment forming part of the wireless communications network a feedback indication indicating that interference measured in a cell corresponding to the second infrastructure equipment exceeds a predetermined threshold,
adapting the transmission of the uplink data and the determined control information to the wireless communications network in response to receiving the feedback indication.

### [Paragraph 29]

The method according to paragraph 28, wherein the feedback indication is a fairness request.

### [Paragraph 30]

The method according to paragraph 29, wherein the fairness request comprises a command instructing the communications device to adapt the transmission of the uplink data and the determined control information in a predetermined manner.

### [Paragraph 31]

The method according to paragraph 28 or 29, wherein the adapting the transmission of the uplink data and the determined control information is performed independently of the wireless communications network.

### [Paragraph 32]

The method according to any of paragraphs 28 to 31, wherein prior to receiving from the second infrastructure equipment the feedback indication, the communications device sends to the second infrastructure equipment the determined control information.

### [Paragraph 33]

The method according to any of paragraphs 28 to 31, wherein prior to receiving from the second infrastructure equipment the feedback indication, the communications device sends to the first infrastructure equipment the determined control information, for transmission from the first infrastructure equipment to the second infrastructure equipment.

### [Paragraph 34]

The method according to any of paragraphs 28 to 33, wherein the receiving from a second infrastructure equipment forming part of the wireless communications network a feedback indication comprises receiving from the first infrastructure equipment a fairness request, the fairness request having been transmitted from the second infrastructure equipment to the first infrastructure equipment.

### [Paragraph 35]

The method according to any of paragraphs 28 to 34, wherein the communications device includes in the control information transmitted to the wireless communications network a location of the communications device.

### [Paragraph 36]

The method according to any of paragraphs 28 to 35, wherein the adapting the transmission of the uplink data and the determined control information to the wireless communications network in response to receiving the feedback indication comprises at least one of the communications device reducing the transmission rate of the communications device transmitting to the first infrastructure equipment, the communications device reducing the transmission power of the communications device transmitting to the first infrastructure equipment, or the communications device ceasing the transmission of uplink data and/or control information to the first infrastructure equipment.

### [Paragraph 37]

A communications device for operation in a wireless communications network, the communications device comprising
a transceiver, configured to transmit signals to and/or receive signals from a first infrastructure equipment forming part of the wireless communications network via a wireless access interface provided by the wireless communications network, the signals representing data,
a controller, configured to control the transceiver, and a memory storing instructions which when executed by the controller cause the communications device to determining that the communication device has uplink data to transmit to the wireless communications network,
determining a plurality of periodically occurring instances of uplink resources of the wireless access interface in which the uplink data is to be transmitted, the uplink resources comprising at least a data resource,
determining, independently from the wireless communications network, control information related to the uplink data,
transmitting to the wireless communications network the determined control information for a particular instance of uplink resources,
transmitting the uplink data to the wireless communications network via the data resource,
receiving from a second infrastructure equipment forming part of the wireless communications network a feedback indication indicating that interference measured in a cell corresponding to the second infrastructure equipment exceeds a predetermined threshold, and
adapting the transmission of the uplink data and the determined control information to the wireless communications network in response to receiving the feedback indication.

### [Paragraph 38]

Circuitry for a communications device for operation in a wireless communications network, the communications device comprising
transceiver circuitry, configured to transmit signals to and/or receive signals from a first infrastructure equipment forming part of the wireless communications network via a wireless access interface provided by the wireless communications network, the signals representing data,
controller circuitry, configured to control the transceiver circuitry, and
a memory storing instructions which when executed by the controller circuitry cause the communications device to
determine that the communication device has uplink data to transmit to the wireless communications network,
determine a plurality of periodically occurring instances of uplink resources of the wireless access interface in which the uplink data is to be transmitted, the uplink resources comprising at least a data resource,
determine, independently from the wireless communications network, control information related to the uplink data,
transmit to the wireless communications network the determined control information for a particular instance of uplink resources,
transmit the uplink data to the wireless communications network via the data resource,
receive from a second infrastructure equipment forming part of the wireless communications network a feedback indication indicating that interference measured in a cell corresponding to the second infrastructure equipment exceeds a predetermined threshold,
adapt the transmission of the uplink data and the determined control information to the wireless communications network in response to receiving the feedback indication.

### [Paragraph 39]

A method of operating an infrastructure equipment forming part of a wireless communications network, the infrastructure equipment being configured to serve a cell containing at least one first communications device via a wireless access interface provided by the infrastructure equipment, the method comprising
receiving control information related to a start of uplink transmission from a second communications device to a second infrastructure equipment via a wireless access interface, the second communications device being in a cell served by the second infrastructure equipment,
receiving at least one uplink transmission from the at least one first communications device, or transmitting at least one downlink transmission to the at least one first communications device,
monitoring interference between the uplink transmission from the second communications device to the second infrastructure equipment and the at least one uplink transmission from the at least one first communications device or at least one downlink transmission to the at least one first communications device,
determining whether the interference exceeds a pre-determined threshold, and
if the interference exceeds the pre-determined threshold, sending to the second communications device a feedback indication.

### [Paragraph 40]

The method of paragraph 39, wherein the control information received by the infrastructure equipment includes a location corresponding to the second communications device and the sending to the second communications device a fairness request comprises scheduling and transmitting to the second communications device a fairness request.

### [Paragraph 41]

The method of either of paragraphs 39 or 40, wherein the sending to the second communications device a fairness request comprises transmitting to the second infrastructure equipment a fairness request, the second infrastructure equipment to transmit the fairness request to the second communications device.

### [Paragraph 42]

An Infrastructure Equipment for Operation in a Wireless Communications Network, the infrastructure equipment comprising
a transceiver, configured to transmit signals to and/or receive signals from at least one first communications device in the wireless communications network via a wireless access interface provided by the wireless communications network, the signals representing data,
a controller, configured to control the transceiver,
a memory storing instructions which when executed by the controller cause the infrastructure equipment to
receive control information related to a start of uplink transmission from a second communications device to a second infrastructure equipment via a wireless access interface, the second communications device being in a cell served by the second infrastructure equipment,
receive at least one uplink transmission from the at least one first communications device, or transmitting at least one downlink transmission to the at least one first communications device,
monitor interference between the uplink transmission from the second communications device to the second infrastructure equipment and the at least one uplink transmission from the at least one first communications device or at least one downlink transmission to the at least one first communications device,
determine whether the interference exceeds a pre-determined threshold, and
if the interference exceeds the pre-determined threshold, transmit to the second communications device or the second infrastructure equipment a feedback indication.

### [Paragraph 43]

Circuitry for an infrastructure equipment for operation in a wireless communications network, the infrastructure equipment comprising
transceiver circuitry, configured to transmit signals to and/or receive signals from at least one first communications device in the wireless communications network via a wireless access interface provided by the wireless communications network, the signals representing data,
controller circuitry, configured to control the transceiver circuitry,
a memory storing instructions which when executed by the controller circuitry cause the infrastructure equipment to
receive control information related to a start of uplink transmission from a second communications device to a second infrastructure equipment via a wireless access interface, the second communications device being in a cell served by the second infrastructure equipment,
receive at least one uplink transmission from the at least one first communications device, or transmitting at least one downlink transmission to the at least one first communications device,
monitor interference between the uplink transmission from the second communications device to the second infrastructure equipment and the at least one uplink transmission from the at least one first communications device or at least one downlink transmission to the at least one first communications device,
determine whether the interference exceeds a pre-determined threshold, and
if the interference exceeds the pre-determined threshold, transmit to the second communications device or the second infrastructure equipment a feedback indication.
   [paragraph 44]

A wireless communications system comprising a communications device according to paragraph 37 and an infrastructure equipment according to paragraph 42.

### [Paragraph 45]

A computer programme comprising instructions which, when loaded onto a computer, cause the computer to perform a method according to any of paragraphs 28 to 36 or paragraphs 39 to 41.

### [Paragraph 46]

A non-transitory computer-readable storage medium storing a computer programme according to paragraph 45.

### [Paragraph 47]

A method of operating a first communications device configured to transmit signals to and/or receive signals from a first infrastructure equipment forming part of a wireless communications network via a wireless access interface provided by the wireless communications network, the method comprising
receiving control information related to a start of downlink transmission from a second infrastructure equipment to a second communications device via a wireless access interface, the second communications device being in a cell served by the second infrastructure equipment,
receiving at least one downlink transmission from the first infrastructure equipment, or transmitting at least one uplink transmission to the first infrastructure equipment,
monitoring interference between the downlink transmission from the second infrastructure equipment to the second communications device and the at least one downlink transmission from the first infrastructure equipment or at least one uplink transmission to the first infrastructure equipment,
determining whether the interference exceeds a pre-determined threshold, and
if the interference exceeds the pre-determined threshold, and if the communications device is configured to communicate with the second infrastructure equipment, sending to the second infrastructure equipment a feedback indication.

### [Paragraph 48]

A Communications Device for Operation in a Wireless Communications Network, the

communications device comprising
a transceiver, configured to transmit signals to and/or receive signals from a first infrastructure equipment forming part of the wireless communications network via a wireless access interface provided by the wireless communications network, the signals representing data,
a controller, configured to control the transceiver, and
a memory storing instructions which when executed by the controller cause the communications device to
receive control information related to a start of downlink transmission from a second infrastructure equipment to a second communications device via a wireless access interface, the second communications device being in a cell served by the second infrastructure equipment,
receive at least one downlink transmission from the first infrastructure equipment, or transmitting at least one uplink transmission to the first infrastructure equipment,
monitor interference between the downlink transmission from the second infrastructure equipment to the second communications device and the at least one downlink transmission from the first infrastructure equipment or at least one uplink transmission to the first infrastructure equipment,
determine whether the interference exceeds a pre-determined threshold, and
if the interference exceeds the pre-determined threshold, and if the communications device is configured to communicate with the second infrastructure equipment, send to the second infrastructure equipment a feedback indication.

### [Paragraph 49]

Circuitry for a communications device for operation in a wireless communications network, the communications device comprising
transceiver circuitry, configured to transmit signals to and/or receive signals from a first infrastructure equipment forming part of the wireless communications network via a wireless access interface provided by the wireless communications network, the signals representing data,
controller circuitry, configured to control the transceiver circuitry, and
a memory storing instructions which when executed by the controller circuitry cause the communications device to
receive control information related to a start of downlink transmission from a second infrastructure equipment to a second communications device via a wireless access interface, the second communications device being in a cell served by the second infrastructure equipment,
receive at least one downlink transmission from the first infrastructure equipment, or transmitting at least one uplink transmission to the first infrastructure equipment,
monitor interference between the downlink transmission from the second infrastructure equipment to the second communications device and the at least one downlink transmission from the first infrastructure equipment or at least one uplink transmission to the first infrastructure equipment,
determine whether the interference exceeds a pre-determined threshold, and
if the interference exceeds the pre-determined threshold, and if the communications device is configured to communicate with the second infrastructure equipment, send to the second infrastructure equipment a feedback indication.

### [Paragraph 50]

A method of operating an infrastructure equipment forming part of a wireless communications network, the infrastructure equipment being configured to serve a cell containing at least one first communications device via a wireless access interface provided by the infrastructure equipment, the method comprising
determining that the infrastructure equipment has downlink data to transmit to the communications device,
determining a plurality of periodically occurring instances of downlink resources of the wireless access interface in which the downlink data is to be transmitted, the downlink resources comprising at least a data resource,
determining control information related to the downlink data,
transmitting to the communications device the determined control information for a particular instance of downlink resources,
transmitting the downlink data to the wireless communications network via the data resource,
receiving from a second communications device forming part of the wireless communications network a feedback indication indicating that interference measured in a cell corresponding to the second communications device exceeds a predetermined threshold, and
adapting the transmission of the downlink data and the determined control information to the communications device in response to receiving the feedback indication.

### [Paragraph 51]

An infrastructure equipment for operation in a wireless communications network, the infrastructure equipment comprising
a transceiver, configured to transmit signals to and/or receive signals from at least one first communications device in the wireless communications network via a wireless access interface provided by the wireless communications network, the signals representing data,
a controller, configured to control the transceiver,
a memory storing instructions which when executed by the controller cause the infrastructure equipment to
determine that the infrastructure equipment has downlink data to transmit to the communications device,
determine a plurality of periodically occurring instances of downlink resources of the wireless access interface in which the downlink data is to be transmitted, the downlink resources comprising at least a data resource,
determine control information related to the downlink data,
transmit to the communications device the determined control information for a particular instance of downlink resources,
transmit the downlink data to the wireless communications network via the data resource,
receive from a second communications device forming part of the wireless communications network a feedback indication indicating that interference measured in a cell corresponding to the second communications device exceeds a predetermined threshold, and
adapt the transmission of the downlink data and the determined control information to the communications device in response to receiving the feedback indication.

### [Paragraph 52]

Circuitry for an infrastructure equipment for operation in a wireless communications network, the infrastructure equipment comprising
transceiver circuitry, configured to transmit signals to and/or receive signals from at least one first communications device in the wireless communications network via a wireless access interface provided by the wireless communications network, the signals representing data,
controller circuitry, configured to control the transceiver circuitry,
a memory storing instructions which when executed by the controller circuitry cause the infrastructure equipment to
determine that the infrastructure equipment has downlink data to transmit to the communications device,
determine a plurality of periodically occurring instances of downlink resources of the wireless access interface in which the downlink data is to be transmitted, the downlink resources comprising at least a data resource,
determine control information related to the downlink data,
transmit to the communications device the determined control information for a particular instance of downlink resources,
transmit the downlink data to the wireless communications network via the data resource,
receive from a second communications device forming part of the wireless communications network a feedback indication indicating that interference measured in a cell corresponding to the second communications device exceeds a predetermined threshold, and
adapt the transmission of the downlink data and the determined control information to the communications device in response to receiving the feedback indication.

### [Paragraph 53]

A wireless communications system comprising a communications device according to paragraph 48 and an infrastructure equipment according to paragraph 51.

### [Paragraph 54]

A computer programme comprising instructions which, when loaded onto a computer, cause the computer to perform a method according to paragraph 47 or paragraph 50.

### [Paragraph 55]

A non-transitory computer-readable storage medium storing a computer programme according to paragraph 54.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v 14.3.0, August 2017.
[3] RP-190726, “Physical layer enhancements for NR ultra-reliable and low latency communication (URLLC)”, Huawei, HiSilicon, RAN #83, March 2019.
[4] RP-201310, “Revised WID: Enhanced Industrial Internet of Things (IOT) and ultra-reliable and low latency communication (URLLC) support for NR,” Nokia, Nokia Shanghai Bell, RAN #88e, July 2020.
[5] European patent application with publication number EP3837895.
[6] European patent application number EP21204071.1.
[7] I-18-131, “NTN predictive uplink scheduling grant and initial parameter provision with RRC signaling or alternative method”.
[8] SYP346404, “UE-based Scheduling and link adaptation methods for UL data transmissions”.
[9] RP-213587, “Study on XR Enhancements for NR”, 3GPP TSG RAN Meeting #94e, December 2021.
[10] R1-2205056, “Capacity Enhancement Techniques for XR”, Qualcomm, RAN1 #109-e.

1. A communications device for operation in a wireless communications network, the communications device comprising
a transceiver, configured to transmit signals to and/or receive signals from an infrastructure equipment forming part of the wireless communications network via a wireless access interface provided by the wireless communications network, the signals representing data,
a controller, configured to control the transceiver, and
a memory storing instructions which when executed by the controller cause the communications device to
determine that the communications device has uplink data to transmit to the wireless communications network,
determine a plurality of periodically occurring instances of uplink resources of the wireless access interface in which the uplink data is to be transmitted, the uplink resources comprising at least a data resource,
determine, independently from the wireless communications network, control information related to the uplink data,
transmit to the wireless communications network the determined control information for a particular one of the instances of uplink resources if a predetermined condition is met, wherein the predetermined condition is at least one of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink resources, and a modulation and coding scheme encoding the uplink data to be transmitted in the particular instance of uplink resources is different to a modulation and coding scheme used to encode uplink data transmitted in a previous instance of uplink resources, and
transmit the uplink data to the wireless communications network via the data resource in each of the plurality of instances of uplink resources.

2. The communications device of claim 1, wherein, if the data resource corresponding to a particular instance of uplink resources is sufficient for the transmission of all the uplink data to be transmitted, the communications device includes in the control information an indication that the uplink data to be transmitted in the particular instance of uplink resources is a start of the uplink data to be transmitted and an indication that the uplink data to be transmitted in the particular instance of uplink resources is an end of the uplink data to be transmitted.

3. The communications device of claim 1, wherein, if the data resource corresponding to a particular instance of uplink resources is sufficient for the transmission of all the uplink data to be transmitted, the communications device includes in the control information an indication that the uplink data to be transmitted in the particular instance of uplink resources is an end of the uplink data to be transmitted and does not include in the control information an indication that the uplink data to be transmitted in the particular instance of uplink resources is a start of the uplink data to be transmitted.

4. The communications device of claim 1, wherein an indication that the uplink data to be transmitted in the particular instance of uplink resources is an end of the uplink data to be transmitted is implicitly indicated to the wireless communications network by the communications device not transmitting uplink data in a next determined instance of uplink resources.

5. The communications device of claim 1, wherein the wireless access interface uses a time division duplex method of multiplexing signals, and
wherein the instructions which when executed by the controller further cause the communications device to
determine at least one OFDM symbol configured by the wireless communications network as a flexible OFDM symbol,
determine that the communications device has more uplink data to transmit to the wireless communications network,
transmit to the wireless communications network as part of the control information an indication to change a configuration of the at least one OFDM symbol from a flexible OFDM symbol to an uplink OFDM symbol, and
transmit to the wireless communications network, via the at least one OFDM symbol, at least one symbol representing uplink data.

6. The communications device of claim 1, wherein the communications device transmits to the wireless communications network as part of the control information at least one parameter related to frequency hopping, and transmits the control information and uplink data to the wireless communications network in accordance with the at least one parameter related to frequency hopping.

7. The communications device of claim 6, wherein the at least one parameter related to frequency hopping includes at least one of a frequency hopping flag bit, an indication of a number of frequency hops, an indication of a frequency hopping offset, and an indication of to which particular instance or instances of uplink resources the at least one parameter relates.

8. The communications device of claim 1, wherein the communications device transmits to the wireless communications network as part of the control information an indication of a waveform and the communications device transmits the control information and/or uplink data to the wireless communications network in accordance with the indication of a waveform.

9. (canceled)

10. The communications device of claim 1, wherein the communications device transmits to the wireless communications network as part of the control information an indication of a DMRS configuration, comprising an indication of a first DMRS configuration or an indication of a second DMRS configuration, and the communications device transmits the control information and uplink data to the wireless communications network in accordance with the indication of a DMRS configuration.

11. The communications device of claim 1, wherein the communications device transmits to the wireless communications network as part of the control information an indication of a DMRS length and the communications device transmits the control information and uplink data to the wireless communications network in accordance with the indication of a DMRS length.

12. The communications device of claim 1, wherein the communications device transmits to the wireless communications network as part of the control information an indication related to additional DMRS resources and the communications device transmits the control information and uplink data to the wireless communications network in accordance with the indication of additional DMRS resources.

13. The communications device of claim 1, wherein the communications device transmits to the wireless communications network as part of the control information an indication of a PUSCH mapping scheme and the communications device transmits the control information and uplink data to the wireless communications network in accordance with the indication of a PUSCH mapping scheme.

14. The communications device of claim 1, wherein the communications device transmits to the wireless communications network as part of the control information an indication that control information is included in a PUSCH channel and the communications device transmits the control information and uplink data to the wireless communications network in accordance with the indication that control information is included in the PUSCH channel.

15. The communications device of claim 1, wherein the communications device transmits to the wireless communications network as part of the control information an indication that the communications device includes, in the PUSCH channel, control information only, and the communications device transmits the control information to the wireless communications network in accordance with the indication that the communications device includes in the PUSCH channel control information only.

16. The communications device of claim 1, wherein the communications device transmits to the wireless communications network as part of the control information an indication of a ratio of transmission power between a transmission of uplink control information, UCI, and PUSCH transmissions, and the communications device transmits the control information and uplink data to the wireless communications network in accordance with the indication of a ratio of transmission power between uplink control information, UCI, and PUSCH transmissions.

17. The communications device of claim 1, wherein the communications device transmits to the wireless communications network as part of the control information an indication of a number of multiple input multiple output, MIMO, layers for PUSCH transmission, and the communications device transmits the control information and/or uplink data to the wireless communications network in accordance with the indication of a number of MIMO layers for PUSCH transmission.

18. The communications device of claim 1, wherein the instructions executed by the controller cause the communications device to further
receive from the wireless communications network an indication of at least one of a coding scheme to be used to encode uplink data and/or control information to be sent to the wireless communications network, a channel quality indicator related to a channel via which the uplink data and/or the control information is to be sent, or a change of a channel to be used to send uplink data and/or control information to the wireless communications network, and
to transmit to the wireless communications network uplink data and/or control information in accordance with the indication received from the wireless communications network.

19. (canceled)

20. A method of operating a communications device configured to transmit signals to and/or receive signals from a wireless communications network via a wireless access interface provided by the wireless communications network, the method comprising
determining that the communications device has uplink data to transmit to the wireless communications network,
determining a plurality of periodically occurring instances of uplink resources of the wireless access interface in which the uplink data is to be transmitted, the uplink resources comprising at least a data resource,
determining, independently from the wireless communications network, control information related to the uplink data,
transmitting the determined control information for a particular instance of uplink resources if a predetermined condition is met, wherein the predetermined condition is at least one of: uplink data to be transmitted in the particular instance of uplink resources is a start of the uplink data to be transmitted, uplink data to be transmitted in the particular instance of uplink resources is an end of the uplink data to be transmitted, an amount of uplink data to be transmitted in the particular instance of uplink resources is different to an amount of uplink data transmitted in a previous instance of uplink data transmission, and a coding scheme encoding the uplink data to be transmitted in the particular instance of uplink resources is different to a coding scheme used to encode uplink data in a previous instance of uplink data transmission, and
transmitting the uplink data to the wireless communications network via the data resource.

21. An infrastructure equipment for operation in a wireless communications network, the infrastructure equipment comprising
a transceiver, configured to transmit signals to and/or receive signals from a communications device in the wireless communications network via a wireless access interface provided by the wireless communications network, the signals representing data,
a controller, configured to control the transceiver,
a memory storing instructions which when executed by the controller cause the infrastructure equipment to
receive control information transmitted from the communications device in a particular instance of periodically occurring uplink resources of the wireless access interface,
receive uplink data transmitted from the communications device in a particular instance of uplink resources, the particular instance of uplink resources being a corresponding particular instance of uplink resources to the particular instance of uplink resources carrying the control information, or a particular instance of uplink resources later than a corresponding particular instance of uplink resources to the particular instance of uplink resources carrying the control information,
decode the uplink data transmitted from the communications device in accordance with the control information received from the communications device.

22. The infrastructure equipment of claim 21, wherein the instructions executed by the controller cause the infrastructure equipment further to
transmit to the communications device an indication of at least one of a coding scheme to be used to encode uplink data and/or control information to be sent to the wireless communications network, a channel quality indicator related to a channel via which the uplink data and/or the control information is to be sent, or a change of a channel to be used to send uplink data and/or control information to the wireless communications network.

23.-55. (canceled)
